(19) United States
(12) Patent Application Publication
(10) Pub. No.: US 2018/0060482 A1
(43) Pub. Date: Mar. 1, 2018

(54) INTERPRETING GENOMIC RESULTS AND PROVIDING TARGETED TREATMENT OPTIONS IN CANCER PATIENTS

(71) Applicant: Intermountain Invention Management, LLC, Salt Lake City, UT (US)

(72) Inventors: Lincoln D. Nadauld, Santa Clara, UT (US); Derrick S. Haslem, St. George, UT (US)

(73) Assignee: Intermountain Invention Management, LLC, Salt Lake City, UT (US)

(21) Appl. No.: 15/693,033

(22) Filed: Aug. 31, 2017

Related U.S. Application Data
(60) Provisional application No. 62/382,087, filed on Aug. 31, 2016.

(51) Int. Cl. G06F 19/18; G06F 19/22; G06N 99/00

(52) U.S. Cl. CPC G06F 19/18; G06F 19/345; G06N 99/005; G06F 19/22

(57) ABSTRACT

A method for creating a clinical interpretation and recommendation for treatment of a cancer patient is disclosed. The method may include generating sequence of DNA, RNA, cDNA, or protein obtained from the patient's tumor or cancer cells. Clinically significant genetic variants and variants of unknown clinical significance may be identified and separately categorized. Therapies to treat tumors or cancer cells, which include the observed genetic variant may be identified and prioritized according to a series of criteria. A board of experts in various oncology-related fields, which may include machine learning platforms and algorithms, may review and further prioritize the list of treatments. The board may then provide a clinical interpretation and recommendation for conveyance to a treating healthcare provider. The clinical interpretation and recommendation may further include a proposal for genetic testing relevant to the patient, surgery, or radiation therapy.

### CROSS-REFERENCE TO RELATED APPLICATION

This application claims the benefit of U.S. Provisional Application Ser. No. 62/382,087, filed Aug. 31, 2016, entitled “Interpreting Genomic Results and Providing Targeted Treatment Options in Cancer Patients,” which is hereby incorporated by reference herein in its entirety, including but not limited to those portions that specifically appear hereinafter, the incorporation by reference being made with the following exception: In the event that any portion of the above-referenced application is inconsistent with this application, this application supersedes said above-referenced application.

### BACKGROUND

This disclosure relates to methods of selecting therapies to treat cancer diseases. More specifically, the disclosure relates to methods of using genetic information derived from the cancer patient's cancer cells combined with expertise of those in the field of oncology to select a cancer therapy.

Cancer is a prevalent and complicated disease, which is the result of somatic aberrations, variants in the patient's germline DNA, or genetic variants that develop in the cancer cells as they divide. The type of genetic variant present in the cancer cells may provide an indication of the behavior of the cancer disease, the cancer patient's prognosis, and which therapies will be most effective.

Precision cancer medicine involves the detection of tumor-specific somatic mutations, including insertions/deletions (indels), single nucleotide variants (SNV), translocations, and copy number alterations (CNA), followed by treatment with therapeutics that specifically target identified actionable alterations. This precision medicine approach has largely been hampered by the high cost of testing and the extended turnaround times associated with in-depth genomic diagnostic analysis. However, advances in genomic technologies, including Next-Generation Sequencing (NGS) and droplet digital PCR (ddPCR), amongst others, have now rendered extended genomic analyses of human malignancies technologically and financially feasible for clinical adoption.

In addition to genetic variants, other variables pertaining to the patient, the patient's disease, and comorbidities accompanying the cancer disease may be relevant to selecting the most appropriate therapy. Consequently, the combined expertise of multiple professionals with extensive training and experience in the field of oncology may be useful to and enhance the power of genetic analysis resulting in a fine-tuning of the therapy selection for each individual patient. Until enough data has been collected addressing every permutation of cancer disease combined with other relevant variables, the combination of associating genetic analysis with input from experts in the field of oncology may result in the most individually designed treatment choice for each patient.

While the combination of a thorough genetic analysis and a team of oncology experts may result in the best treatment choices and thereby provide improved care for a cancer patient, the majority of treating healthcare providers do not have access to these tools. In addition, many treating healthcare providers do not have the training and expertise to take advantage of the benefits these tools offer.

For at least these reasons, a method is needed that gives treating healthcare providers across a broad geographical area the benefits of these tools. The method may combine a combination of some or all of the following tools, including machine learning, bioinformatics, DNA/protein sequencing, genetic variant analysis, data from available clinical and non-clinical studies, and the expertise of relevant experts in various oncology-related fields. A method that takes advantage of these tools in a way that extracts the most benefit from each tool and conveys that benefit to treating healthcare providers and their cancer patients is disclosed.

### BRIEF SUMMARY

The disclosure describes a method of creating a clinical recommendation for treatment of a cancer patient, which includes analysis of a DNA/RNA/protein sequence, genetic variants therein, and consideration by a board, including experts and/or machine learning platforms and algorithms, in various oncology-related fields. The method may begin by isolating genomic DNA from a tumor biopsy or a sample that includes cells of hematological cancers. Sequence of the genomic DNA, dDNA, RNA, or protein may be generated using any of a variety of sequencing techniques known in the art.

The sequence of the genomic DNA, cDNA, RNA, or protein may be analyzed to identify genetic variants. The genetic variants may be divided into one of two categories. The first category may include clinically actionable genetic variants. Clinically actionable genetic variants include a genomic or genetic variant wherein a relevant governing body has approved a therapy to treat cancers with or without that genetic variant; and, genetic variants wherein there is preclinical or clinical evidence that an approved drug might target that genetic variant. The second category may include genetic variants of unknown clinical significance. These include genetic variants for which the function of that variant has not been defined, though there may be drugs to target other variants within that gene.

Drug therapies approved to treat clinically actionable genetic variants are then identified and paired with the clinically actionable genetic variants to create a list of drug-variant matches. The drug-variant matches are divided into two groups: drug-variant matches for which the approved therapy is approved to treat a cancer of the type found in the cancer patient and drug-variant matches for which the approved therapy is approved to treat cancers not of the type found in the cancer patient.

The board (which, as used herein, is interchangeable with the term “molecular tumor board” and may include a machine learning platform and/or algorithm) may consider the two groups of drug-variant matches and divide them into those for which clinical data are available and those for which only animal and in vitro data are available. The board may sub-prioritize the drug-variant matches for which clinical data are available based on the clinical data and the experience of the board. The board may sub-prioritize the drug-variant matches for which only animal and in vitro data are available based on the results of the animal and in vitro studies and the experience of the board. In some embodiments, the group of drug-variant matches for which clinical data are available may be assigned a higher priority than the group of drug-variant matches for which only animal and in vitro data are available.

The board may then propose a list of recommended therapies for the cancer patient. The list of recommended therapies may be listed in an order according to their likelihood of achieving the desired clinical outcome as determined by the board. The recommended therapies may be presented in a clinical recommendation to be conveyed to the cancer patient's treating healthcare provider. The board may also consider whether genetic testing is indicated and may provide a recommendation for genetic testing in the clinical recommendation. In some embodiments, the board may recommend a surgical procedure, radiation therapy, or both along with a drug therapy. In some embodiments, the drug therapy may include one or more small molecules, one or more biologics, or both.

Upon considering the clinical recommendation and choosing a drug therapy, the disclosed method may include assisting the treating healthcare provider in acquiring the drug or combination of drugs in the chosen drug therapy.

### BRIEF DESCRIPTION OF THE DRAWINGS

Non-limiting and non-exhaustive implementations of the disclosure are described with reference to the following figures, wherein like reference numerals refer to like parts throughout the various views unless otherwise specified. Advantages of the disclosure will become better understood with regard to the following description and accompanying drawings where:

FIG. 1A is a flow chart illustrating an embodiment of the disclosed method for identifying a treatment for a cancer patient in accordance with the teachings and principles of the disclosure;

FIG. 1B is a flow chart illustrating a continuation of the method presented in FIG. 1A in accordance with the teachings and principles of the disclosure;

FIG. 2 is a flow chart illustrating an embodiment of the activities of a board in the field of oncology, which may follow the method presented in FIGS. 1A and 1B in accordance with the teachings and principles of the disclosure;

FIG. 3 is a flow chart illustrating a method that may be executed to prepare the genetic report comprising a DNA/RNA/protein sequence and categorized genetic variants to be used as described in FIG. 1A and in accordance with the teachings and principles of the disclosure;

FIG. 4 illustrates a schematic diagram of a system for interpreting genomic results and a machine learning classification system for interpreting genomic results in accordance with the teachings and principles of the disclosure;

FIG. 5 illustrates a schematic block diagram illustrating operation of a classification system in accordance with the teachings and principles of the disclosure;

FIG. 6 is a schematic diagram illustrating example configuration of a deep neural network, according to one implementation;

FIG. 7A is an illustration of an embodiment of an example clinical recommendation interpreting genomic results in accordance with the teachings and principles of the disclosure;

FIG. 7B is an illustration of an embodiment of an example clinical recommendation interpreting genomic results in accordance with the teachings and principles of the disclosure;

FIG. 8 is a schematic flow chart diagram illustrating a method for classifying or interpreting genomic results in a tissue sample or specimen in accordance with the teachings and principles of the disclosure; and

FIG. 9 illustrates a block diagram of an example computing device in accordance with the teachings and principles of the disclosure.

### DETAILED DESCRIPTION

The disclosure extends to methods, systems, and computer program products for interpreting genomic results and to systems, methods, and platforms for machine learning classification of genomic results. In the following description of the disclosure, reference is made to the accompanying drawings, which form a part hereof, and in which is shown by way of illustration specific implementations in which the disclosure is may be practiced. It is understood that other implementations may be utilized and structural changes may be made without departing from the scope of the disclosure.

It will be readily understood that he embodiments, as generally described herein, are exemplary. The following more detailed description of various embodiments is not intended to limit the scope of the present disclosure, but is merely representative of various embodiments. Moreover, the order of the steps or actions of the methods disclosed herein may be changed by those skilled in the art without departing from the scope of the present disclosure. In other words, unless a specific order f steps or actions is required for proper operation of the embodiment, the order or use of specific steps or actions may be modified.

Reference in the specification to “one embodiment” or “an embodiment” means that a particular feature, structure, or characteristic described regarding the embodiment is included in at least one embodiment, but is not a requirement that such feature, structure, or characteristic be present in any particular embodiment unless expressly set forth in the claims as being present. The appearances of the phrase “in one embodiment” in various places may not necessarily limit the inclusion of a particular element of the disclosure to a single embodiment, rather, that element may be included in other or all embodiments discussed herein.

Furthermore, the described features, structures, or characteristics of embodiments of the disclosure may be combined in any suitable manner in one or more embodiments. In the following description, numerous specific details are provided to provide a thorough understanding of the disclosure. One skilled in the relevant art will recognize, however, that embodiments of the disclosure may be practiced without one or more of the specific details, or other methods, components, materials, and so forth. In other instances, well-known structures, materials, or operations are not shown or described in detail to avoid obscuring aspects of the disclosure.

It should be noted that, as used in this specification and the appended claims, singular forms such as “a,” “an,” and “the” may include the plural unless the context clearly dictates otherwise. Thus, for example, it is understood that a reference to “a connection element” or the like may include one or more of such connection elements. In particular, with respect to the construction of claims, it is further understood that a reference to “a connection element” or the like reads on an infringing method or device that has more than one connection element, since such infringing device has “a connection element” plus additional connection elements. Accordingly, the use of the singular article “a,” “an,” and “the” is considered open-ended to include more than a single element, unless expressly limited to a single element by such language as “only,” or “single.”

The disclosure includes a method for selecting a therapy for a cancer patient, which combines genetic analyses of a deoxyribonucleic acid (hereinafter “DNA”) sequence, a ribonucleic acid (hereinafter “RNA”) sequence, and/or a protein sequence, the use of genetic variants, and the expertise and experience of various oncology professionals. As used herein, the term “genetic” means: relating to heredity, genes, or the sequence of DNA, RNA, or protein. Accordingly, genetic data includes genomic analysis (analysis of genomic DNA), analysis of cDNA, analysis of RNA, or proteomic data. “Variant,” as used herein, means a disparity in sequence or other modification of the biomolecule including posttranslational modification of protein, methylation of DNA, and RNA modification. Thus, it will be appreciated that observed genetic variants include, but are not limited to, single nucleotide polymorphisms (SNPs), single nucleotide variants (SNVs), fusions and translocations, large structural variations, copy number alterations, insertions/deletions, and other genomic, genetic, nucleotide, transcriptomic, proteomic or molecular variations and aberrations. The present application discloses systems, methods, and devices for interpreting genomic results and also relates to systems, methods, and platforms for machine learning classification of genomic results. Precision cancer medicine involves the detection of tumor-specific somatic mutations, including insertions/deletions (indels), single nucleotide variants (SNV), translocations, and copy number alterations (CNA), followed by treatment with therapeutics that specifically target identified actionable alterations. This precision medicine approach has largely been hampered by the high cost of testing and the extended turnaround times associated with in-depth genomic diagnostic analysis. However, advances in genomic technologies, including Next-Generation Sequencing (NGS) and droplet digital PCR (ddPCR), amongst others, have now rendered extended genomic analyses of human malignancies technologically and financially feasible for clinical adoption.

Simultaneous with these advances in genomic technologies, there have been significant advances in two overlapping areas of cancer research, each with major clinical ramifications, namely: (1) a greater understanding of the underlying genomic alterations and molecular mechanisms of cancer, and (2) the development of novel therapeutic agents and biomolecules that exploit specific genomic aberrations in tumors. These advances are the underpinnings of the new precision cancer medicine clinical paradigm.

In the precision medicine approach to cancer, the healthcare provider and patient utilize the identification of specific genetic aberrations that affect cancer related genes to better inform treatment decisions. The underlying rationale is that this personalized diagnostic approach will lead to a clinical recommendation for targeted cancer therapies, which will ultimately result in improved clinical outcomes. This approach has been successfully applied to single tumor types with pre-determined genomic variants such as EGFR-positive non-small cell lung cancer, and BRAF-positive melanoma, while previous studies reveal that precision medicine can improve survival in a single cancer type. Earlier studies indicate that targeted therapies given to patients whose tumors harbor specific alterations, may improve outcomes as measured by tumor responsiveness. However, the effect of precision medicine's impact on survival remain unknown, compared to standard therapies and the effect of implementing sophisticated diagnostic technologies, such as NGS, on the costs of cancer care.

The method may include receiving molecular data from a tissue sample collected directly from a biopsy or a liquid biopsy, and may include receiving any molecular data collected from any part of the patient, including the patient's fluids, such as blood, saliva, or urine. As used herein, the term “sample” includes any biological material, including, but not limited to, DNA, RNA, protein, tissue, biological fluid, biopsy material, and biological waste.

The method may include generating genomic DNA sequence, cDNA or RNA sequence, or protein sequence from cancerous cells or tissue isolated from a cancer patient. The genomic DNA, RNA, or protein may be acquired by collecting a biopsy from a solid tumor. Alternatively, the genomic DNA, RNA or protein may be acquired by collecting cells of hematological cancers. Such hematological cancers may include, but are not limited to, various types of leukemia, myeloma, and lymphoma. The sample may be collected using techniques known in the art, which include, but are not limited to, collecting a blood sample, urine sample, or bone marrow biopsy from the cancer patient.

Genomic DNA used in DNA sequencing may be isolated from the solid tumor biopsy or the hematological cancer cells using DNA isolation and/or amplification techniques known in the art. The DNA sequencing technique may be any of those known in the art. The DNA sequence may be generated from genomic DNA isolated from the tumor or hematological cancer cells or from material, which includes some or all the cellular material in addition to genomic DNA. The hematological cancer cells from which DNA sequence is generated may first be isolated from a sample which initially includes the hematological cancer cells as well as non-cancerous cells. Alternatively, the DNA sequence may be generated from a sample that comprises a mix of non-cancerous cells and hematological cancer cells without isolating the hematological cancer cells prior to generating DNA sequence.

In some embodiments, ribonucleic acid (RNA) may be isolated from a hematological cancer cell sample or tumor biopsy and converted to cDNA. The sequence of the cDNA may be determined and analyzed for genetic variants as described herein and the genetic variants presented in the genetic report as described herein.

In some embodiments, protein may be isolated from a hematological cancer cell sample or biopsy and sequenced using protein sequencing techniques known in the art. The sequence of the protein may be determined and analyzed for genetic variants as described herein and the genetic variants presented in the genetic report as described herein.

The DNA/RNA/protein sequence may be analyzed to identify genetic variants in the genome of the cancer cells. The genetic variants may include chromosomal translocations, mutations, deletions, and combinations thereof. In some embodiments, appropriate bioinformatic computer programming, which may include non-transitory computer readable medium, may be utilized to analyze the DNA/RNA/protein sequence and identify genetic variants. The identified genetic variants may be categorized into one of two categories: clinically actionable genetic variants and genetic variants of unknown clinical significance. As used herein, a clinically actionable genetic variant is defined as follows: a genetic variant wherein a relevant governing body has approved a therapy to treat cancers with or without that genetic variant; and, genetic variants wherein there is preclinical or clinical evidence that an approved drug might target that genetic variant. A clinically actionable genetic variant may be a genetic variant found in a hematological cancer or solid tumor of the type from which the cancer patient suffers and for which a therapy has been approved by a relevant governing body to treat that type of cancer. A clinically actionable genetic variant may also be a genetic variant for which a therapy has been approved by a relevant governing body to treat a hematological cancer or solid tumor other than the type from which the cancer patient suffers, but which harbor the genetic variant presented in the cancer patient's genetic report. Additionally, as used herein, genetic variants of unknown clinical significance are those genetic variants for which the function of that variant has not been defined, though there may be drugs to target other variants within that gene.

A genetic report may then be prepared that may include the identified genetic variants and their categorization as either clinically significant genetic variants or genetic variants of unknown clinical significance. The genetic report may also include the DNA/RNA/protein sequence generated from the tumor biopsy or hematological cancer cells.

Some embodiments include one or more of the following: collecting a biopsy from the solid tumor or a sample including hematological cancer cells, isolating genomic DNA, RNA or protein from the biopsy or sample, generating sequence of the genomic DNA, RNA (which may be done by generating and sequencing cDNA) or protein, identifying genetic variants, categorizing genetic variants into one of the two categories described herein, and preparing a genetic report. Other embodiments begin the process by receiving the genetic report, which was prepared by another and proceeding with its analysis as described below.

A board may be assembled that includes individuals who possess varying types of training, expertise, and experience in the field of oncology and/or machine learning platforms and algorithms. In an embodiment, the board may include professionals from various fields of study, which may be relevant to the interpretation of the patient's condition and/or treatment. For example, such professionals may include, but are not limited to, scientists from various fields of study, biologists, genomic experts, oncologists, radiologists, pharmacists, surgeons, nurses, internists, and/or a variety of other healthcare professionals. In an embodiment, the board may include machine learning platforms and algorithms, which may be relevant to the interpretation of the patient's condition and/or treatment. In some instances, healthcare professionals that are uniquely relevant to a particular cancer patient's treatment may be added to the board to consult on that patient's treatment options. For example, one cancer patient may suffer from ovarian cancer. A gynecologist or specialist in treating gynecological cancers may be added to the board for this cancer patient. Another patient may suffer from lung cancer. A pulmonologist may be added to the board to discuss that cancer patient's treatment. In some embodiments, the board may come together in the same location to perform the tasks and analyses described herein. In other embodiments, some members of the board may participate by communicating through technology known in the art, for example, telephone or video conferencing. In some embodiments, a board member may provide his or her opinions, recommendations, or other applicable information without attending a meeting of the board members either in-person or remotely. In the latter example, the board member may be asked to serve on the board to provide a specific piece of information or analyses, the value of which is not dependent on discussion with other board members.

The genetic report may be presented to the board that may review and enumerate the categorized genetic variants provided therein. The board may identify members of a list or drug therapies, each of which may be known to be effective against a solid tumor or hematologic cancer cell that harbors at least one of the clinically actionable genetic variants presented in the cancer patient's genetic report. Each clinically actionable genetic variant and its associated approved drug therapy are referred to herein as drug-variant matches. Specifically, drug-variant match, as used herein, means a clinically actionable genetic variant associated with a drug or combination of drugs, the drug or combination of drugs having been approved by a relevant governing body to treat cancers which harbor the clinically actionable genetic variant.

Drug-variant matches may be divided into two therapy categories. The first therapy category may include drug-variant matches comprising drug therapies that are approved by a relevant governing body to treat a cancer cell or tumor of a type present in the cancer patient. For example, a drug-variant match in the first therapy category may include a drug or combination of drugs approved to treat a lung cancer, which includes the genetic variant presented in the cancer patient's genetic report when the cancer patient suffers from lung cancer. The drug-variant matches in the second therapy category may include a drug or combination of drugs that were approved by a relevant governing body to treat a cancer cell or tumor of a type other than that from which the cancer patient suffers, but which harbors a genetic variant presented in the cancer patient's genetic report. For example, a drug-variant match in the second therapy category may include a drug or combination of drugs that is effective in treating colon cancers, which harbor a genetic variant presented in the cancer patient's genetic report. However, the cancer patient may suffer from liver cancer, but not colon cancer.

The relevant governing body that approved the drugs in the first and second therapy categories may vary by nation or jurisdiction. For example, in the United States of America, the relevant governing body may be the Food and Drug Administration (FDA). In another example, in Canada, the relevant governing body may be Health Canada.

The board may then prioritize the therapies in each of the first and second therapy categories. In some embodiments, the therapies in the first therapy category may be assigned a higher priority than the therapies in the second therapy category. The board may then sub-prioritize the therapies within the first and second therapy categories based on the available clinical data and data from animal and in vitro studies, which investigate the therapies or components thereof.

In some embodiments, the therapies for which clinical data is available may be prioritized higher than those for which no clinical data is available and for which only data from animal or in vitro studies are available for evaluation.

As used herein, clinical data means data collected from studies in which the therapy is tested in the species for which it is intended for use. For example, clinical data for a drug being tested for treatment of cancer in humans includes a study in which the drug treatment was administered to humans. Clinical data for a drug being tested for treatment of cancer in animals is derived from a study in which the drug therapy was administered to the animal species contemplated for use of the drug therapy. Clinical data may be derived from one or more phases of a clinical trial which may assess safety, efficacy, or both safety and efficacy. If a drug therapy is intended for use in humans, animal data as used herein, may include data derived from studies involving any non-human animal, invertebrate, or insect. These animals may include, but are not limited to, frogs, mice, rats, rabbits, chimpanzees or other non-human primates, insects, and invertebrates. In vitro data may be derived from studies that include primary cell cultures or immortalized cell lines. Also, as used herein, in vitro data may be derived from studies which include ex vivo data, which include tissue or tissues excised from a living organism and kept alive during the drug testing.

The therapies within the first and second therapy categories may then be sub-prioritized based on available clinical data, data from animal studies, and data from in vitro studies. The board may perform the sub-prioritization by evaluating the data from these studies with reference to their own training, expertise, and experience.

The board may then create a clinical recommendation for treatment of the cancer patient. The clinical recommendation may include a list of recommended therapies for the cancer patient which may be prioritized in an order based on the recommendation of the board.

In some embodiments, the board may consider genetic testing for the cancer patient, the cancer patient's family, or those within a geographical area in which the cancer patient resides or spends time. In some embodiments, a recommendation for genetic testing may be included in the clinical recommendation. This genetic testing may be used to further characterize the genetic variants in the tumor or hematological cancer or to screen the patient's family members for risk of developing cancer. If the genetic variant is thought to be acquired through heredity, the recommendation may limit the genetic testing to biological family members. If the genetic variant is thought to be acquired through exposure to environmental substances, the genetic testing may be recommended for those in the cancer patient's household or a geographical area regardless of biological relation to the cancer patient.

The clinical recommendation may then be provided to the cancer patient's treating healthcare provider for consideration. The treating healthcare provider may choose one of the treatment options provided in the clinical recommendation. In some embodiments, the disclosed method includes assisting the treating healthcare provider in the procurement of one or more pharmaceutical compounds recommended in the chosen treatment for the cancer patient.

In some embodiments, the pharmaceutical compounds included in the clinical recommendation may include one or more small molecules.

In some embodiments, the pharmaceutical compounds included in the clinical recommendation may include one or more biologics.

In some embodiments, the pharmaceutical compounds included in the clinical recommendation may include one or more small molecules and one or more biologics.

In some embodiments, in addition to pharmaceutical compounds, the clinical recommendation may include a recommendation for a surgical procedure.

In some embodiments, in addition to pharmaceutical compounds, the clinical recommendation may include a recommendation for a radiation therapy.

In some embodiments, in addition to pharmaceutical compounds, the clinical recommendation may include a recommendation for both a surgical procedure and radiation therapy.

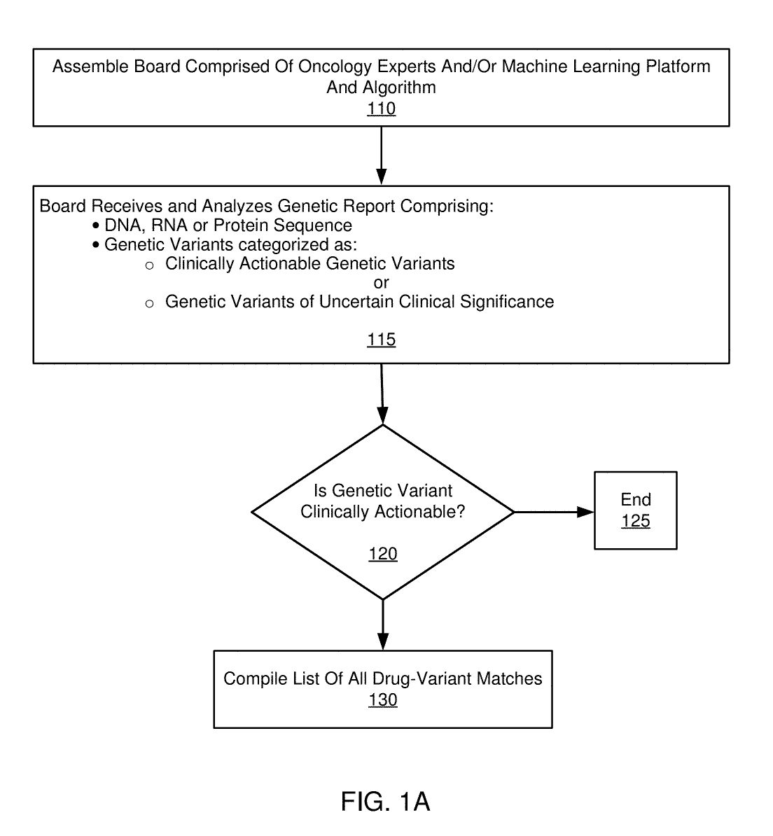

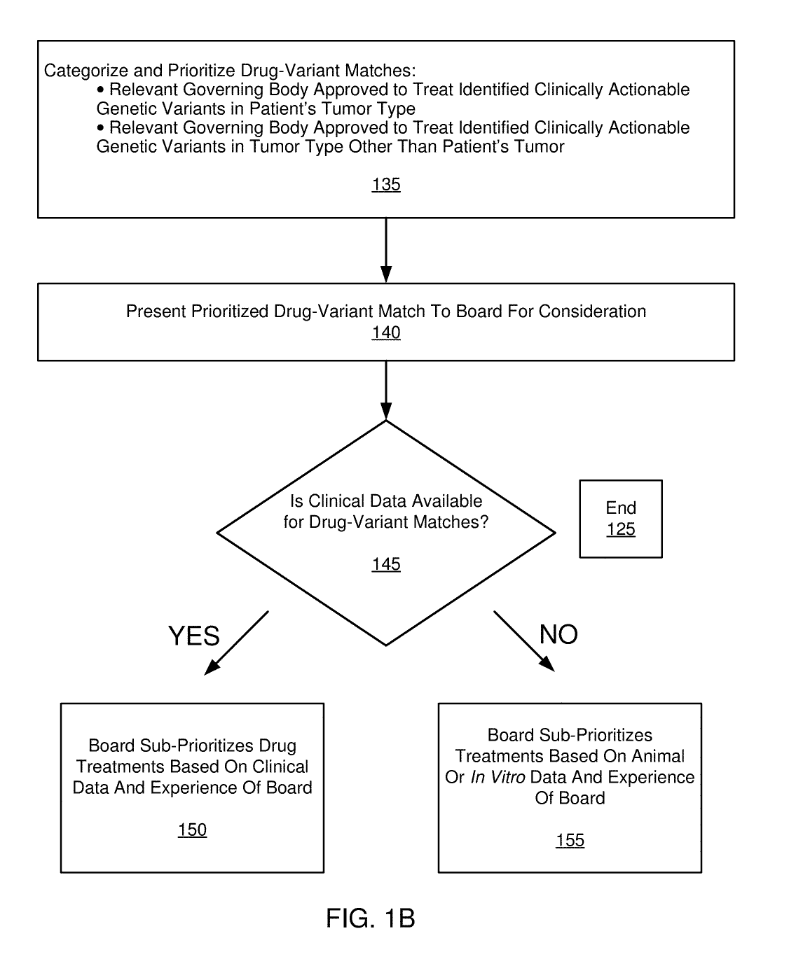

Referring now to the drawings, FIG. 1A and FIG. 1B provide a flowchart illustrating an embodiment of the process that may be used to select an appropriate therapy for a cancer patient. Beginning with FIG. 1A, a board is assembled at 110, which may include experts in the field of oncology and/or a machine learning platform and algorithm. This may include, but are not limited to, scientists from various fields of study, biologists, genomic experts, oncologists, radiologists, pharmacists, surgeons, nurses, internists, and/or a variety of other healthcare professionals, which may be relevant to the cancer patient's treatment. In some instances, healthcare professionals that are uniquely relevant to a particular cancer patient's therapy selection may be added to the board to consult on that patient's therapy options.

At 115, the board receives and analyzes a genetic report pertaining to the cancer patient. The genetic report may include DNA sequence, RNA sequence, or protein sequence generated from a sample, such as a DNA sequence from a genomic DNA sample, derived from the patient's tumor or cancer cells. The sequence has been analyzed to identify genetic variants which are provided in the genetic report. The genetic variants may be categorized into two categories and their association with the appropriate category may be presented in the genetic report. The first category may include clinically actionable genetic variants. The second category may include genetic variants of uncertain clinical significance.

At 120, the question is asked whether the genetic variant(s) identified in the genetic report include one or more clinically actionable variants. If there is no clinically actionable variant in the genetic report, the disclosed process ends (at 125). For example, the genetic report may include only variants of uncertain clinical significance, in which case, the process ends at 125. If a clinically actionable variant is found in the sequence of the genomic DNA, for example, the method continues to 130 which is to compile a list of drug-variant matches.

The embodiment of the method disclosed in FIG. 1A is continued according to the method illustrated in FIG. 1B. At 135, the drug-variant matches are categorized and prioritized. Highest priority is given to drug-variant matches including drugs or a combination of drugs that have been approved by a relevant governing body to treat cancers of the type found in the cancer patient and which harbor a genetic variant identified in the cancer patient's cancer. Lower priority is given to drug-variant matches including drugs or a combination of drugs that have been approved by a relevant governing body to treat cancers other than found in the cancer patient and that harbor a genetic variant identified in the cancer patient's cancer, but which are not approved to treat cancers of the type found in the cancer patient.

The prioritized drug-variant matches at 135 are then presented to the board for consideration (at 140). The question is asked whether there are available clinical data associated with the drug-variant matches (at 145). Clinical data may be derived from one or more phases of a clinical trial, which may assess safety, efficacy, or both safety and efficacy.

If clinical data are available for the one or more drug therapies in the one or more drug-variant matches, the board may use the clinical data to sub-prioritize the drug therapies in the drug-variant matches (at 150). The board may also draw on the experience of the board members and the published scientific and medical literature to sub-prioritize the drug therapies at 150.

If no clinical data are available for the drug therapies in the drug-variant matches, the board considers data from studies in which the drug therapies in the drug-variant matches were tested in animal species or in vitro (at 155) to sub-prioritized the drug therapies in the drug-variant matches. The board may also draw on the experience of the board members to sub-prioritize the drug therapies at 155.

In some embodiments, the drug-variant matches may include drug therapies for which clinical data are available as well as drug therapies for which only animal and/or in vitro data are available. In these embodiments, the two groups will be individually sub-prioritized as illustrated in FIG. 1B.

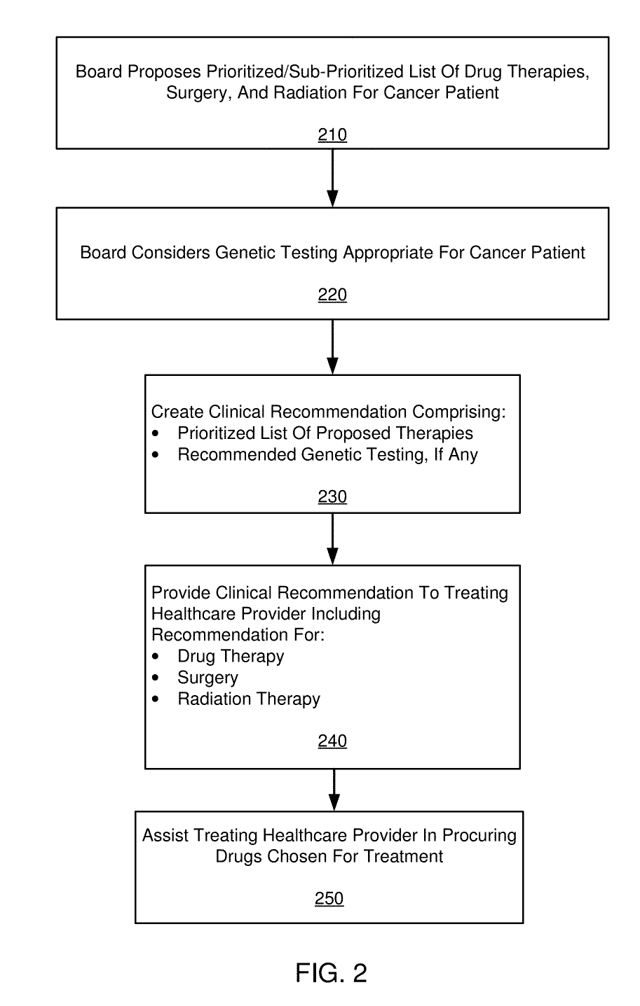

At the end of the process disclosed in FIG. 1A and FIG. 1B, the board will have prepared a prioritized and sub-prioritized list of drug therapies for the cancer patient. At this point, the process may continue as disclosed according to the flowchart presented in FIG. 2. At 210 of FIG. 2, the board proposes a list of drug therapies, surgery(ies), and/or radiation for the cancer patient, which may be prepared according to the process illustrated in FIG. 1A and 1B.

The board may also consider whether the cancer patient or the patient's family members would benefit from genetic testing (at 220). This genetic testing may be used to further characterize the genetic variants in the cancer patient's hematological cancer cells or tumor or to screen the patient's family members for risk of developing cancer. If the genetic variant is thought to be acquired through heredity, the proposal may limit the genetic testing to biological family members. If the genetic variant is thought to be acquired through exposure to environmental substances, the genetic testing may be recommended for those in the cancer patient's household or a geographical area regardless of biological relation to the cancer patient.

At 230, a clinical recommendation is created, which includes the proposed list of sub-prioritized drug therapies with indications as to their order of priority according to the board's recommendation. If the board recommends genetic testing, the clinical recommendation may also include the recommended genetic testing and may also designate whether the genetic testing is recommended for the cancer patient, the cancer patient's family members, those in a geographical area, or a combination thereof.

The clinical recommendation may then be conveyed to the treating healthcare provider (at 240), which may include interpretations or recommendations for drug therapy, surgery, and/or radiation therapy. The treating healthcare provider may consider the proposed therapies in the clinical recommendation and choose one for the cancer patient. If the treating healthcare provider desires, the method may include assisting the treating healthcare provider in the task of procuring the one or more drugs in the chosen treatment (at 250).

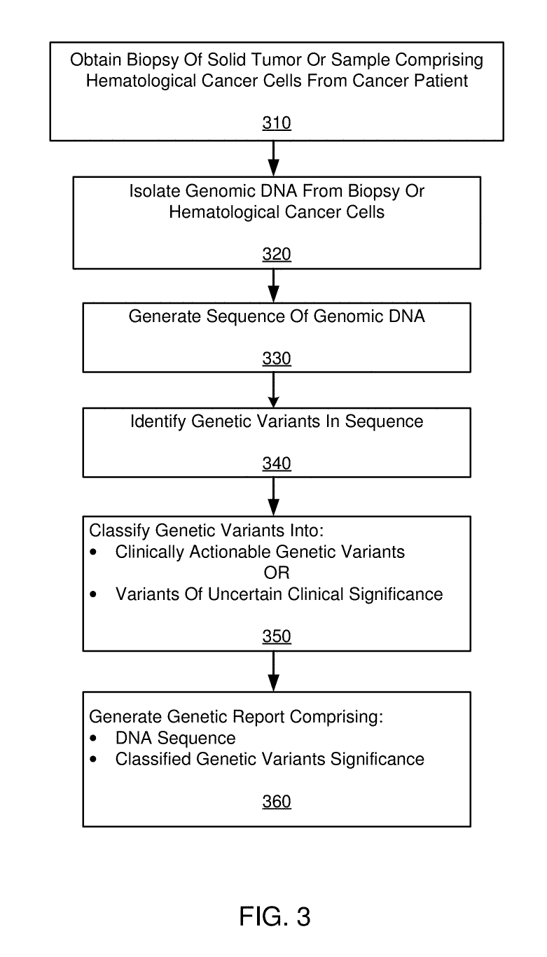

FIG. 3 shows a flowchart illustrating a method that may be undertaken to prepare the genetic report as referenced in FIG. 1A. At 310, a biopsy of a solid tumor or a sample including cells from a hematological cancer are collected from the cancer patient. The cells from the hematological cancer may be fully or partially isolated from non-cancerous cells in the sample prior to the isolating genomic DNA or the genomic DNA may be isolated without separating cell types.

Genomic DNA may be isolated from the solid tumor biopsy or the hematological cancer cells (at 320). The sequence of the genomic DNA isolated at 320 may be generated according to a variety of techniques known in the art (at 330).

At 340, the sequence of the genomic DNA may be analyzed to identify genetic variants. The genetic variants may then be classified (at 350) into clinically actionable genetic variants and genetic variants of uncertain clinical significance as defined herein. A genetic report may then be created that may include the sequence of the genomic DNA and the genetic variants (at 360). The genetic variants may be presented according to their assigned category: clinically actionable genetic variants or genetic variants of uncertain clinical significance.

As one of skill in the relevant art will understand, some embodiments of the disclosed method may be conducted without steps disclosed in FIG. 3. More specifically, the steps in FIG. 3 may be performed by one or more external entities, which may provide the sequence, genetic variants, and categorized genetic variants for use in the process disclosed at least in FIG. 1A and 1B. Alternatively, in some embodiments, one or more of the steps disclosed in FIG. 3 may be performed by the same entity as that which performs the steps in FIG. 1A and 1B.

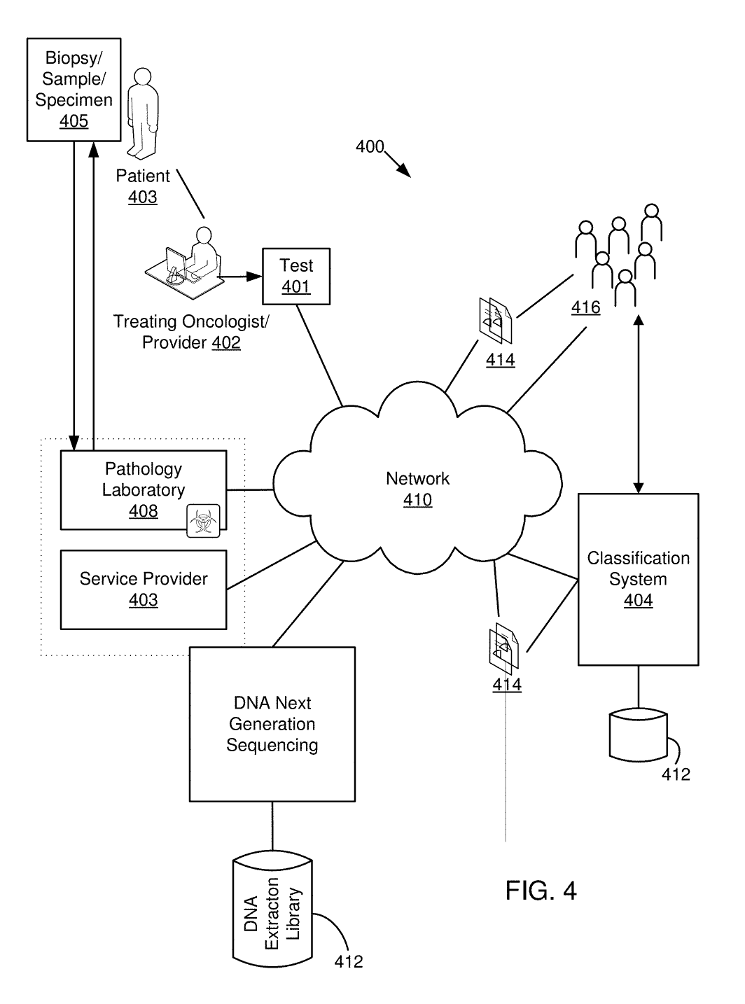

Referring now to FIG. 4, the disclosure provides for a personalized approach to testing, diagnosing, and treating cancer in patients. The disclosure provides a unique system and method 400 that analyzes the genetic makeup of a patient's cancer and employs a team of skilled molecular tumor specialists and/or machine learning algorithms to review each test and determine how to most effectively treat that cancer case. The approach disclosed herein provides treating oncologists with the information and support needed to prepare a customized, targeted treatment plan for each patient.

As illustrated FIG. 4, a system and method for providing targeted cancer treatment plan for each patient may include a treating physician 402, which may be an oncologist, or other health care provider logging into a service portal/system over a computer network 410 or otherwise and orders a test 401 from a service provider 403 for a targeted cancer panel that detects 96 genomic alterations. The service provider 403 may send a specimen or sample kit (test kit) to the treating oncologist 402 to obtain a biopsy or tumor sample 405 from a patient 403. The sample 405 is sent from the treating oncologist 402 and received by the service provider 403 and/or a pathology laboratory 408. The pathology laboratory 408 extracts DNA from the patient's tumor specimen or sample and stores the extracted results in a DNA extraction library 412 for DNA next generation sequencing. DNA next generation sequencing may be performed. The service provider may then identify whether there are any clinically actionable variants by detecting whether any of the cancer-related genes appear altered in the gene sequence. It will be appreciated that in an embodiment the disclosure may detect 96 cancer-related genes, or in an embodiment the disclosure may detect more than 96 cancer-related genes, or in an embodiment the disclosure may detect less than 96 cancer-related genes without departing from the scope of the disclosure. The service provider 403 may also analyze the gene sequence to determine what, if any, genetic mutations exist. A molecular tumor board 416 may comprise cancer and genomic experts, scientists, and physicians. The molecular tumor board 416 may analyze the bioinformatics, and provide options and interpretations, including suggesting whether additional tests are needed, and/or providing effective treatment options based on the data and interpretations. The information and recommendations are compiled into a clinical recommendation shown as clinical recommendation 414, which the ordering physician/oncologist 402 can easily access over a computer network 410, including over the internet. The molecular tumor board 416 may use a machine learning classification system 404 to provide and analyze bioinformatics and suggest additional tests or effective treatment options based on the data.

It will be appreciated that the disclosure contemplates testing and treating all possible gene mutation types. The test used by the disclosure examines a larger portion of a patient's DNA, rather than just a genetic hotspot, to better detect which, if any, of 96 types of cancer mutations exist. When compared to traditional diagnostic tests and treatment, the systems and methods provided by the disclosure significantly improve outcomes for patients and their families.

The systems and methods disclosed herein may be performed rapidly and is an interactive process that reduces time from receiving/obtaining a sample to providing findings and recommendations that are delivered to oncologists in a comprehensive report/clinical recommendation. In one example embodiment, the time from receiving/obtaining a sample to providing findings and recommendations that are delivered to oncologists in a comprehensive report/clinical recommendation is 16 days or less. When genetic variants are found, a molecular tumor board and/or the classification system 404 provides an interactive functionality that allows oncologists to order the recommendation medications directly from the clinical recommendation with just one click of a computer mouse.

The disclosed systems and methods support patients and doctors through their entire diagnosis and treatment process. The systems and methods disclosed herein utilize oncologists and cancer specialists to provide tests and sequence DNA, RNA, or protein isolated from tissue samples before collaborating to analyze and evaluate findings, recommend treatments, and monitor outcomes.

The test 401 may be utilized to understand and determine the type of cancer disease from which a cancer patient suffers. The test 401 detects any irregularities or cancer markers within a patient's genes and DNA. The test 401 utilized by the systems and methods disclosed herein may identify 96 genes that can play a part in developing cancer. The test 401 looks at each one of the 96 genes to determine if any show abnormalities. The systems and methods disclosed may use a biopsy, sample, or specimen 405 with greater depth and coverage (greater than 300×) to yield a more accurate gene sequence. The test 401 may be ordered by registering/logging into a provider's system and filling out an order form. It will be appreciated that the disclosure may utilize any test 401 that provides a targeted cancer panel without departing from the scope of the disclosure. In one embodiment, the assay looks at whole exome sequencing (WES) instead of just a hotspot mutation region.

It will be appreciated that each type of cancer responds to different treatments. Accordingly, the test 401 utilized by the systems and methods disclosed pinpoints what genes indicate cancerous mutations, and then the molecular tumor board 416 and/or classification system 404 disclosed herein determine what type of cancer disease is present in the cancer patient, and how to best treat it.

Once a test is ordered, a specimen kit may be sent to the treating physician or other health professional to obtain a sample or specimen. In one embodiment, the following may be requirements for the sample. First, a fresh biopsy sample may be taken while observing storage requirements (discussed in one embodiment below). Second, the biopsy will be Formalin Fixed Paraffin Embedded Tissue (FFPE) (block or minimum of 60 microns of paraffin shavings). Third, the specimen is made into 12 unstained-unbaked slides cut at 5-10 microns, 2 mm FFPE tissue punch of tumor rich area. FFPE tissue curls or preserved fresh tissue. Fourth, each specimen may have a minimum of 40% tumor content submitted for testing. All samples may be properly labeled with two identifiers.

In an embodiment, the specimen or sample collection process may comprise pulling a block, including pathologist review for tumor and selection of an appropriate spot on the block for micro dissection. The process may further comprise performing a micro dissection, including using a 2 mm punch to extract specific part of the block and submitting the specimen in a 1.5 mL vial to a laboratory. The process may further comprise completing paperwork, including paperwork submitted as part of a specimen kit and labeling any tube, vial and other paperwork with a barcode identifier as noted below.

In an embodiment, the storage and transportation requirements for a specimen may comprise sending a specimen request with all of the appropriate handling information to a pathology laboratory (or receiving at a pathology laboratory). All samples may be transported in the kit provided to comply with regulatory or other biohazard standards. Shipping documents and materials may be provided in the kit. The specimen may be shipped in a cooled container during summer months to protect from excessive heat.

It will be appreciated that in an embodiment, the sample may contain at least 40% tumor content. Less than 40% tumor content may be considered quantity non-sufficient (QNS). Specimens fixed/processed in alternative fixatives or heavy metal fixatives may not be used. It will further be appreciated that no decalcified specimens may be used.

Using standard operating protocol (SOP), genomic DNA, RNA, or protein is extracted from a tissue sample 405 and over 1200 regions of cancer-related genes, or their RNA or protein products, are sequenced. These targeted regions may be sequenced on massively paired-end parallel sequencing platforms using the oligo-capture method. Through this method, the mean depth coverage (>300×) can be observed, genetic variants can be detected, and a complete analysis of the targeted regions can be performed.

In an embodiment, to analyze sequenced nucleotides from the patient's exome, an analytical pipeline that includes a standardized and validated level of mean depth coverage has been developed and deployed. The analytical pipeline ensures a qualitative and highly accurate sequence. The sequence may be compared to an existing standard genomics reference sample. To complete the process, a bioinformatician and lab director/designee may approve a derived consensus, and then cross-validate the results.

A bioinformatics pipeline may comprise data analysis and algorithms, test scripts, and test or training datasets.

In an embodiment, the bioinformatics and interpretation process may comprise a pre-processing of raw data, including patient's genomic data retrieved from the sequencer. The bioinformatics and interpretation process may also comprise variant controlling, including genetic variants identified using software technology and genetic variants matched to database records with summarization about variants. The bioinformatics and interpretation process may further comprise clinical interpretation, including individualized reports being generated for each patient, treatment information for variants that are clinically actionable, and listing of available clinical trials. The clinical interpretation may be included in a clinical recommendation to be provided to the patient's oncologist or other healthcare provider.

In an embodiment, clinical interpretation may include categorizing actionable genomic alterations as such if they are linked to an approved therapy in the solid tumor examined or another solid tumor (e.g., PTEN rearrangement in lung or breast cancer, respectively), a known or suspected contraindication to a given therapy (example, EGFR Gly719Ala in colorectal cancer), or a clinical study (e.g., Cisplatin inhibition in a tumor with AKT1 rs2494752).

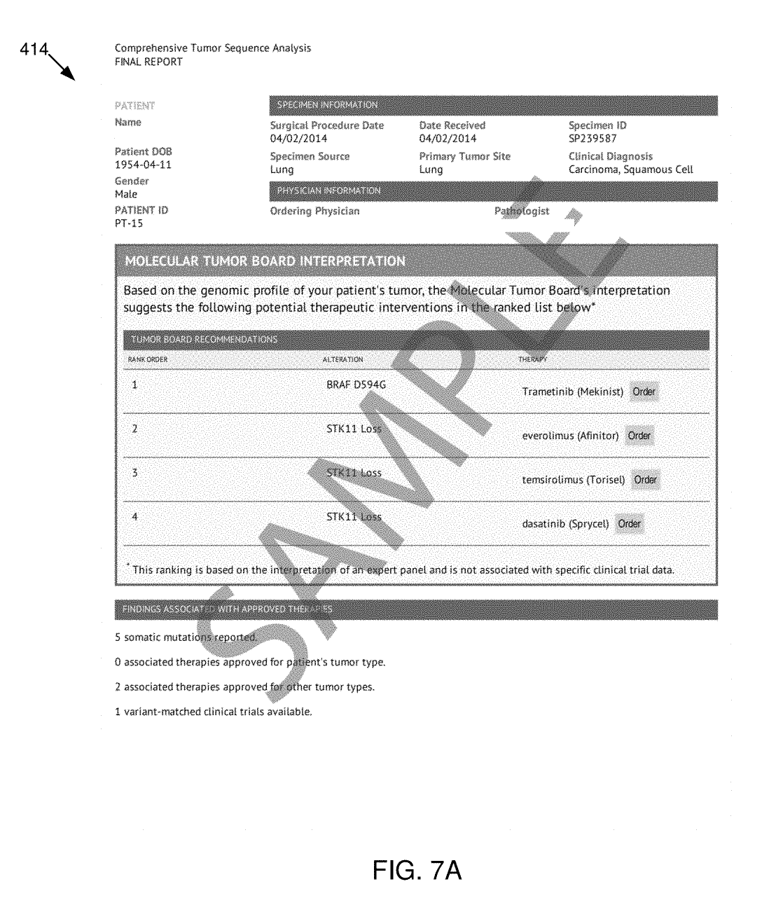

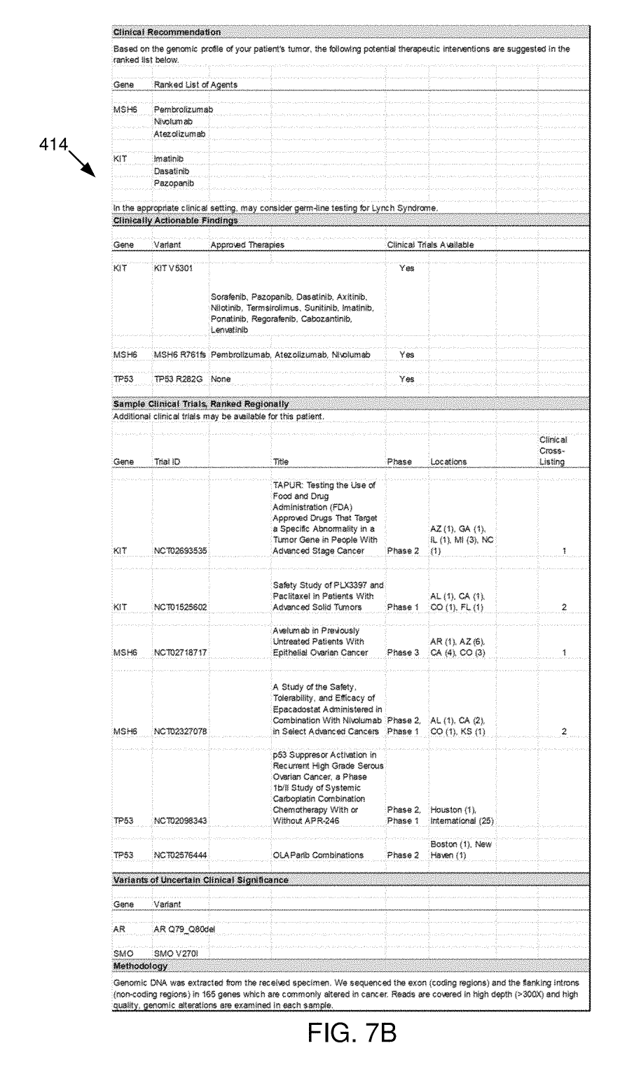

After the molecular tumor board 416 and/or the classification system 404 has had a chance to analyze the data and information and form conclusions, a clinical recommendation in the form of clinical recommendation 414 may be generated and prepared (either automatically or manually) to share with the treating physician/oncologist 402 who requested the analysis. The clinical recommendation 414 outlines the recommendations and includes a link to procure the recommended, targeted drugs. The clinical recommendation 414 may also provide a ranked list of recommended therapies for the treating healthcare provider to consider. This personalized and patient-specific clinical recommendation also highlights relevant clinical trials. See FIGS. 7A and 7B, which are embodiments of sample clinical recommendations including recommendations for relevant clinical trials, for further detail.

### Example Embodiment

The following paragraphs comprise an example embodiment of the disclosure. This example embodiment of the disclosure has been clinically established in a confidential setting. Patients with advanced, refractory cancer were referred to a precision medicine clinic where they received genomic testing, an in-depth interpretation of the genomic results from a multi-institutional molecular tumor board and/or classification system, and a list of treatment options for implementation at the discretion of the treating oncologist.

The disclosure illustrates the progression free survival (PFS), total costs, and per week of survival costs, associated with the initial cohort of patients who received targeted treatment in the precision cancer medicine program, compared to control patients who received standard chemotherapy or best supportive care.

The disclosure compares the outcomes of cancer patients who were treated with precision cancer targeted therapies with a historical control cohort treated with a non-targeted approach.

Subjects: Male and female adults with measurable recurrent/metastatic solid tumors, who failed standard first-line treatments proposed by the National Comprehensive Cancer Network (NCCN) guidelines, were included. Other inclusion requirements were Eastern Cooperative Oncology Group (ECOG) performance status of 0, 1, or 2; and adequate renal, hepatic and bone marrow function. Patients who had only brain metastases or whose brain metastases had not been controlled for >3 months, patients who were participating in a clinical trial with an experimental drug, or patients who had known infections or other concurrent severe and/or uncontrolled medical disease, which could compromise participation were excluded. Pregnant or breastfeeding women also were excluded.

All patients in the precision medicine group had tumor molecular abnormalities for which the molecular tumor board (MTB) provided an interpretation. Actionable mutations were defined as variants that had been validated in the peer-reviewed literature, and for which a targeted therapy was available. The molecular tumor board selected treatment options only for actionable mutations for which there was published clinical evidence. Patients included in the control group received standard of care genomic testing only, without molecular tumor board interpretation or molecularly targeted therapy beyond the relevant standard of care.

Sample size: A simulation power analysis was performed for a Cox proportional hazards model with 100,000 simulations. In determining the sample size that was used, the methodology of Tsimberidou et al. was considered. Their initial comparison of a personalized medicine program, in the context of early clinical trials, evaluated a cohort of previously treated patients with advanced malignancy of various histological subtypes; and estimated the median survival of the control and cohorts to be 2.2 and 5.2 months, respectively.

Selection of endpoints: The primary endpoint was Progression Free Survival (PFS) according to radiographic determination of tumor progression Response Evaluation Criteria In Solid Tumors (RECIST) 1.1. Tumor measurements by CT imaging were obtained prior to treatment initiation and every 8 weeks thereafter. Secondary endpoints included healthcare associated cost of care.

Blinding: Clinician researchers were blinded to the identities of those in the control cohort. Cancer registrars selected the control cohort and provided data about the controls to the statistician (AB).

### Statistical Methods

A Cox proportional hazards model was fit for progression-free survival. Treatment, gender, age, cancer type, and treatment line greater than 3 were included in this model. A full versus reduced likelihood ratio test was performed comparing the full model to a reduced model containing only treatment. This test showed that the reduced model adequately fits the data and only treatment is needed in the model (p=0.508). Basic demographics, as well as two-sample t-tests and linear regression models, were created to investigate the cost of therapy. Collecting demographic variables and using the Cox model controlled for confounding factors.

### Cost Analysis

In calculating patient costs, a payer perspective was adopted. Patient costs were estimated using standard payer charges. Only charges incurred between the treatment line start and end dates were included in the total charge estimates for each patient. Patient costs included all amounts for patient treatment, toxicity, patient sequencing and targeted drug therapy. Treatment costs included all facility-based and clinic-based charges for both targeted and control patients associated with treatment including chemotherapy, drug, radiology and lab costs. Palliative care costs were limited to CMS daily reimbursement charge rates. Toxicity costs included all patient charges associated with treating the side effects of treatment. Patients sequencing costs for target patients were obtained from the test provider based upon estimated payer reimbursement rates. Drug cost data was drawn from local specialty pharmacies and drug manufacturers based upon estimated payer reimbursement rates including estimates of any patient out-of-pocket costs. A discount rate was not applied to costs to adjust for the time value of money. Given the limitations on availability of quality of life data for control patients, PFS weeks were not quality adjusted. The mean per patient cost per PFS week was calculated by adding the costs per PFS week for each patient and dividing by the total number of patients. Statistical comparisons of costs between precision medicine and control groups were performed using a two-sided Wilcoxon Rank Sum test.

### Molecular Diagnostic Testing

All samples analyzed were either formalin fixed paraffin embedded (FFPE) or fresh samples. Patient samples were analyzed in a Clinical Laboratory Improvement Amendments (CLIA)-certified laboratory. Genomic analysis included NGS-based oligo-selective exon sequencing of 96 cancer-related genes: ABL1, AKT1, ALK, APC, ATM, AURKA, AURKB, AXL, BCL2, BRAF, BRCA1, BRCA2, CCND1, CDH1, CDK2, CDK4, CDK5, CDK6, CDK8, CDK9, CDK12, CDKN2A, CEBPA, CSF1R, CTNNB1, CYP2D6, DDR2, DNMT3A, DPYD, EGFR, EPCAM, ERBB2, ERBB3, ERBB4, ERCC1, ERCC2, ERCC3, ERCC5, ERCC6, EZH2, ESR1, FGFR1, FGFR2, FGFR3, FGFR4, FLT3, GNA11, GNAQ, GNAS, HNF1A, HRAS, IDH1, IDH2, JAK2, JAK3, KDR, KIT, KRAS, MAP2K1, MAP2K2, MAPK1, MET, MLH1, MPL, MRE11, MSH2, MTOR, MSH6, MYC, MUTYH, NOTCH1, NPM1, NRAS, PARP1, PARP2, PDGFRA, PIK3CA, PMS2, PTCH1, PTCH2, PTEN, PTPN11, RB1, RET, RUNX1, SMAD4, SMARCB1, SMO, SRC, STK11, TET2, TP53, UGT1A1, VEGFA, VHL, WT1. It will be appreciated that the 96 cancer-related genes noted above are exemplary and genomic analysis of more than the 96 cancer-related genes identified above may be utilized by the disclosure without departing from the scope of the disclosure. Sample tumor concentration of at least 40% was verified by board certified anatomic pathologists. Samples were extracted using Promega DNA kit (ReliaPrep FFPE gonad miniprep system) or Qiagen extraction kits (Puregene blood core Kit A) for FFPE and fresh samples, respectively. DNA shearing was performed using a Covaris ultrasonicator (M220) to an average of 500 bp lengths. Additional sample preparation, library preparation and Next-Generation Sequencing utilized the TOMAseq kit (adaptor, extension and capture sets) according to the manufacturer's protocol and instructions. Library quantification was performed with a Bio-Rad q200 droplet digital PCR analyzer. Sequencing was performed on the MiSeq (IIlumina) platform. Data analysis, including curation, interpretation, alignment and quality checks were implemented using legacy algorithms and the variant calling was done using freebayes. Patient samples were compared to a reference genome and genetic variants including, copy number alterations, point mutations, frameshift mutations, translocations, and single nucleotide polymorphisms were identified and reported. Some samples were initially tested by an external laboratory (Caris Biosciences, Foundation Medicine, TOMA Biosciences) and those with sufficient quantity were subsequently re-analyzed using the 96-gene panel described above.

### Results

After obtaining informed consent, 61 patients were evaluated who had both an actionable mutation and subsequently received targeted therapy based on the actionable mutation (precision cancer medicine), defined as known variants validated in peer-reviewed literature for which a targeted therapy was available. Given the heterogeneous nature of the treatment cohort in terms of tumor type, age, and gender, their outcomes were compared with the outcomes of control patients that were matched to treatment patients according to tumor type, age, gender and number of previous treatment lines. Institutional enterprise data warehouse was searched to identify historical control patients who had received standard therapy, between July 2010 and January 2015, and could be matched, according to age, gender, diagnosis and number of previous treatment lines, to patients who received precision medicine. Of the 61 patients with an actionable mutation who had received precision medicine, 36 had an institutional historical match (25 patients did not have an historical match). Outcomes data were gathered from those 36 patients who received precision medicine and the 36 matched patients who received standard therapy, including standard molecular testing, for a total of 72 patients. Table 1 lists patients' demographic characteristics by treatment type. No significant differences were found between precision medicine and standard therapy groups except for race/ethnicity, where the precision medicine arm was 100% (n=36) non-Hispanic white and the historical arm was 83.3% (n=30) non-Hispanic white, 2.8% (n=1) non-Hispanic Black, 11.1% (n=4) white and non-white Hispanic, and 2.8% (n=1) other race/ethnicity. Mean age at time of treatment was 67.8 years for the precision medicine group and 67.0 years for the control group (P=0.748). Both groups were 61% male (n=44). Four precision medicine patients were matched at a later line than their controls resulting in an average line of treatment of 3.1 and 2.9 for the precision medicine and control groups, respectively (P=0.168). The cancer types were identically matched for both groups and comprised of patients with diverse solid tumor types, encompassing ten different histologically distinct cancers. Non-small cell lung cancer (NSCLC) was the largest subtype (n=11, 31%) in both cohorts (Table 1).

TABLE 1

| | Precision | | | |
|---|---|---|---|---|
| | Medicine | | Control | |
| Characteristic | No. | % | No. | % |
| Mean age, years | 67.8 | | 67 | |
| Gender | | | | |
| male | 22 | 61.1 | 22 | 61.1 |
| female | 14 | 38.9 | 14 | 38.9 |
| Race | | | | |
| non-Hispanic White | 36 | 100 | 30 | 83.3 |
| non-Hispanic Black | 0 | 0 | 1 | 2.8 |
| white and non-white | 0 | 0 | 4 | 11.1 |
| Hispanic | | | | |
| Other | 0 | 0 | 1 | 2.8 |
| Line of Treatment | | | | |
| 1st line | 0 | 0 | 1 | 2.8 |
| 2nd line | 19 | 52.8 | 19 | 52.8 |
| 3rd line | 9 | 25 | 8 | 22.2 |
| 4th line | 1 | 2.8 | 3 | 8.3 |
| 5th line | 2 | 5.6 | 1 | 2.8 |
| 6th line | 4 | 11.1 | 3 | 8.3 |
| 7th line | 1 | 2.8 | 1 | 2.8 |
| Mean | 3.1 | | 2.9 | |
| Type of Cancer | | | | |
| Bladder | 2 | 5.6 | 2 | 5.6 |
| Breast | 5 | 13.9 | 5 | 13.9 |
| Cholangio | 1 | 2.8 | 1 | 2.8 |
| Colon | 8 | 22.2 | 8 | 22.2 |
| Gastric | 1 | 2.8 | 1 | 2.8 |
| Head and Neck | 4 | 11.1 | 4 | 11.1 |
| Lung | 11 | 30.6 | 11 | 30.6 |
| Melanoma | 1 | 2.8 | 1 | 2.8 |
| Ovary | 1 | 2.8 | 1 | 2.8 |
| Pancreas | 2 | 5.6 | 2 | 5.6 |

Table 1 lists the various characteristics of the targeted treatment and control treatment cohorts, including gender, race, number of previous treatment lines (Line of Treatment), and types of cancers in those cohorts. Numbers (No.) and percentages (%) are listed above.

The clinically actionable variant and targeted therapy for each precision medicine cohort patient was listed. Patients in the historical control cohort had appropriate standard molecular testing according to NCCN guidelines at the time of their diagnosis. Three patients in the precision medicine cohort with non-small cell lung cancer, adenocarcinoma, were found to harbor validated EGFR mutations and received erlotinib; the EGFR mutations were not identified at the time of initial diagnosis.

The protocol-specified primary endpoint of PFS was significantly prolonged in the precision medicine group compared to the control group (mean PFS, 22.9 v 12.0 weeks, respectively; P=0.002). More specifically, precision medicine was associated with a 53% decreased risk of progression (adjusted hazard ratio, 0.47; 95% CI 0.29 to 0.75; P=0.002) when adjusted for age, gender, histological diagnosis and number of previous treatment lines. At the time of the conclusion, four patients (11%) in the precision medicine arm had not yet progressed. A sensitivity analysis suggested that a difference in patient performance status between the two cohorts was unlikely to account for the difference in PFS. The cohort of 25 patients for whom there was not an historical institutional match, also demonstrated a prolonged PFS compared to the control cohort (19.3 weeks; p=0.026).

To determine the costs associated with the two treatment approaches, a healthcare-related cost analysis was performed. All of the patients from each cohort were evaluated and identified 22 matched patient pairs who had received all of their care within the system, and therefore had complete cost data available. An analysis of PFS in this subset of 22 matched patient pairs revealed the same, statistically significant PFS improvement in the precision medicine cohort compared to the standard therapy cohort (21.4 vs 11.0 weeks, p=0.004). As expected, total costs per patient during the period were higher for the precision medicine treatment group than the control group ($91,790 vs $40,782 per patient, P=0.002). Drug costs were the main factor contributing to the higher cost for precision medicine patients ($59,259 vs $20,189 per patient, P<0.001). Patients in the precision medicine had longer survival times resulting in lower patient costs per PFS week than the control group ($4,665 vs $5,000 per week, P=0.126), but did not reach a level of significance.

### Discussion

The findings disclosed herein examine both survival and the healthcare related costs associated with precision cancer medicine in a retrospective cohort of patients. The results suggest a survival benefit for patients who received precision cancer medicine treatment, compared to patients who received standard therapy. A subset analysis of patients who received all care within the system determined that the costs associated with each cohort was not associated with a per week increase in healthcare costs. The simultaneous improvement in PFS, without increasing per week costs, suggests that a precision medicine approach may be a feasible option in refractory cancer patients.

In a study, Tsimberidou and colleagues evaluated the outcomes associated with a phase I personalized medicine program and found that patients who received therapy based on specific molecular alterations, independent of tumor type, experienced improved survival. Similarly, Kris et al. reported improved survival in lung cancer patients when selecting therapies based on oncogenic driver mutations. While the results of the disclosure, along with those reported by Tsimberidou et al. and Kris et al., were not randomized trials, they nevertheless suggest that molecularly guided therapies may improve survival in advanced, refractory cancer patients.

While the improvement in PFS identified in this disclosure partially results from identifying, and treating, previously known molecularly distinct cancer subtypes, such as EGFR-positive lung cancer (n=3 in the targeted treatment cohort), the majority (n=33) of cases resulted from targeting distinct molecular alterations in diverse tumor types, agnostic of histological subtype. Many of the durable responses were the result of identifying well-known molecular alterations from a single cancer subtype, for example, an activating cKIT mutation, commonly found in GIST, and targeting that alteration in a histologically different cancer, such as melanoma. Similar responses were seen in FGFR1-amplified squamous cell lung cancer, FGFR2-mutant cholangiocarcinoma, and MEK1-activated NSCLC. While similar responses in some tumor subtypes with these alterations have been reported previously, as single case reports or case series, the findings of the disclosure suggest that genomic profiling of diverse tumor subtypes, followed by molecularly targeted treatment, may improve outcomes.

The majority of patients in the control cohort were historical in nature, having received their treatment within the same institution within the previous five years. The retrospective nature of the control cohort, in particular, raises the possibility of bias in the analysis. Controlling for the number of previous treatment lines that a patient received prior to enrollment serves to mitigate the risk of bias, but does not completely eliminate the possibility. A statistical sensitivity analysis, included in the Supplement, affirms that a difference in performance status between the two cohorts was unlikely to account for the difference in progression free survival.

The cost associated with implementing novel medical treatment approaches has been historically difficult to measure, due to limitations on data availability and data sharing. Contrastingly, the cost associated with precision cancer medicine remains a primary question for both payers and providers, alike. That question was addressed by analyzing the costs associated with both cohorts. The overall costs of treatment, including cost of testing and cost of drug, were higher in the precision medicine cohort, as might be expected in a cohort that experiences an increased survival time. Evaluating the two cohorts on a cost per week basis revealed that the two groups are not statistically different and drug-related costs remained the primary driver of charges for both cohorts. In an era of increasing healthcare costs, and static resources, measuring the value of treatment becomes critical to sustainability. While the costs of large-scale genomic testing have historically precluded widespread adoption of precision medicine, the equivalence in cost per PFS week between the two cohorts suggests that widespread adoption of precision cancer medicine may no longer be constrained by economic metrics.

A major question surrounding the implementation of precision cancer medicine is its relevance in the community setting where nearly eighty-five percent of cancer patients treated in the United States receive their care. Developing a model for the clinical implementation of precision medicine in a community setting, therefore, is advisable in determining whether this approach warrants further consideration as a viable option for the vast majority of patients with advanced cancer. The survival and cost outcomes reported here were generated entirely in an integrated health delivery system with patients receiving treatment in a community cancer center and suggest that precision cancer medicine can be applied to the community setting with measurable patient benefit.

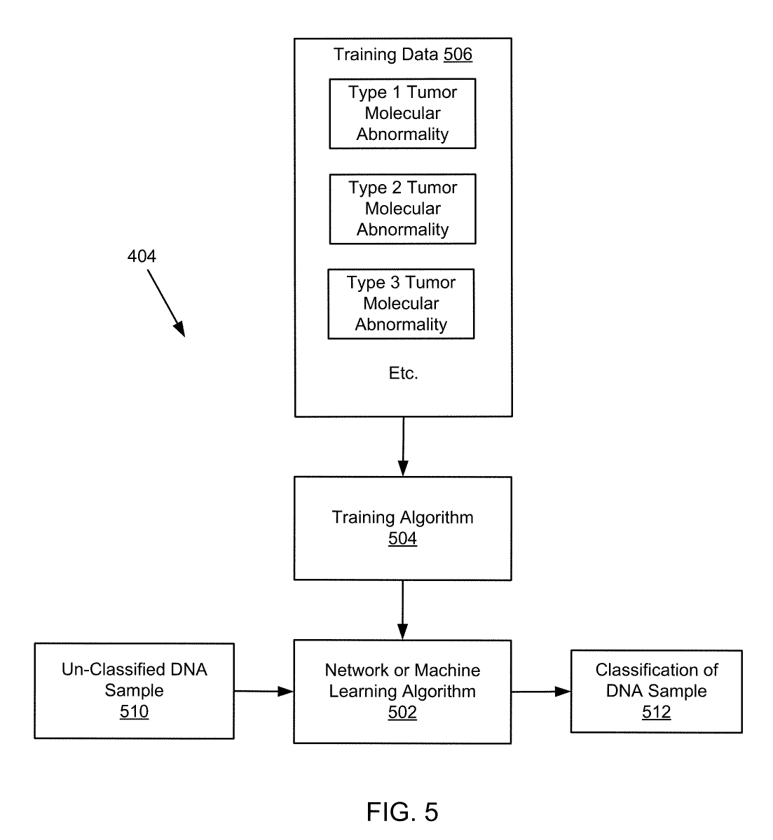

Referring now to FIG. 5, there is illustrated a schematic block diagram illustrating operation of a classification system 404 in accordance with the teachings and principles of the disclosure according to one embodiment. In one embodiment, a network or machine learning algorithm 502 (which may also be referred to as a hypothesis), may be trained and used for identifying and classifying or detecting genes and mutations within genes as well as to provide and analyze bioinformatics and suggest additional tests or effective treatment options based on the data. The network or machine learning algorithm 502 may include a neural network, for example, a deep convolution neural network, or other machine learning model or algorithm for classifying or identifying genes and gene mutations and to provide and analyze bioinformatics and suggest additional tests or effective treatment options based on the data.

In one embodiment, the network or machine learning algorithm 502 is trained using a training algorithm 504 based on training data 506. The training data 506 may include genetic mutation data from the DNA library 412 and their respective designated classifications. Genetic mutation data may include DNA sequences and alterations. For example, the training data may include data classified as a certain tumor molecular abnormality/genetic variant of a first type and data classified as a certain tumor molecular abnormality/genetic variant of a second type. The types of data classified as a certain tumor molecular abnormality/genetic variant may vary significantly based on the type of examination or report that is needed. Training data from other sources may also be used. For example, training data for any tumor molecular abnormality or genetic mutation (cancer causing) that are to be identified by the machine learning algorithm 502 may be provided. Using the training data, the training algorithm 504 may train the machine learning algorithm 502. For example, the training algorithm 504 may use any type or combination of supervised or unsupervised machine learning algorithms.

Once the network or machine learning algorithm 502 is trained, the network or machine learning algorithm 502 may be used to identify or predict the type of data classified as a certain tumor molecular abnormality/genetic mutation/genetic variant. For example, an unclassified DNA sample 510 (or previously classified DNA sample with the classification information removed) is provided to the network or machine learning algorithm 502 and the network or machine learning algorithm 502 outputs a classification 512 of the DNA sample. For example, the network or machine learning algorithm 502 may be targeted to detecting whether a specific type of data classified as a certain tumor molecular abnormality/genetic variant is present in the un-classified DNA sample 510. Alternatively, the classification 512 may indicate one of many types that may be detected by the network or machine learning algorithm 502. For example, the network or machine learning algorithm 502 may provide a classification that indicates which type of tumor molecular abnormality/genetic variant is present in the un-classified DNA sample 510. During training, the classification may be compared to a human classification from the molecular tumor board 416 to determine how accurate the network or machine learning algorithm 502 is. If the classification 512 is incorrect, the un-classified DNA sample 510 may be assigned a classification from a human and used as training data 506 to further improve the network or machine learning algorithm 502.

In one embodiment, both offline and online training of the network or machine learning algorithm 502 may be performed. For example, after an initial number of rounds of training, an initial accuracy level may be achieved. The network or machine learning algorithm 502 may then be used to assist in classification with close review by human workers, such as the molecular tumor board 416. As additional data comes in the data may be classified by the network or machine learning algorithm 502, reviewed by a human, and then added to a body of training data for use in further refining training of the network or machine learning algorithm 502. Thus, the more the network or machine learning algorithm 502 is used, the better accuracy it may achieve. As the accuracy is improved, less and less oversight of human workers may be needed.

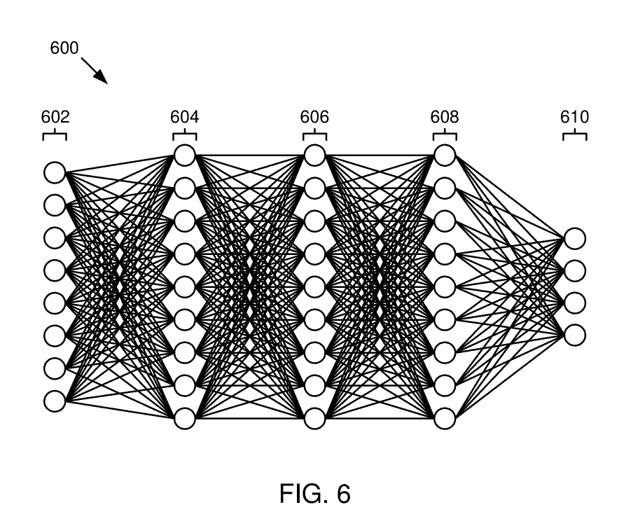

Referring now to FIG. 6, a schematic diagram is shown illustrating an example configuration of a deep neural network 600, according to one embodiment. Deep neural networks are feed-forward computational graphs with input nodes (such as input nodes 602), one or more hidden layers (such as hidden layers 604, 606, and 608) and output nodes (for example, output nodes 610). For classification of contents or information about a type of tumor molecular abnormality/genetic variant, values for the input are assigned to the input nodes, and then fed through the hidden layers 604, 606, 608 of the network, passing a number of non-linear transformations. At the end of the computation, the output nodes 610 yield values that correspond to the class inferred by the neural network. The number of input nodes 602, hidden layers 604-608, and output notes 610 is illustrative only. For example, different tumor molecular abnormalities/genetic variants may include a number of input nodes 602, and thus may have hundreds, thousands, or other number of input nodes.

According to one embodiment, a deep neural network 600 of FIG. 6 may be used to classify the content(s) of a type of tumor molecular abnormality/genetic mutation/genetic variant into different classes.

Deep neural networks may be used to distinguish between DNA sequence variants for different tumor types, if they are trained based on examples. For example, to create a deep neural network that is able to detect and classify the type of tumor molecular abnormalities/genetic mutations, a large amount of known example tumor molecular abnormalities/genetic variants with a label assigned to each that corresponds to the type of tumor molecular abnormality/genetic mutation/genetic variant may be needed. The labeled data can be a large challenge for training deep neural networks as humans are often required to assign labels to the training images (which often go into the millions). Thus, the time and equipment to acquire the image as well as hand label them can be expensive. Once the images with labels (training data) are acquired, the network may be trained.

It will be appreciated that the data stored in the DNA library 412 may be remotely stored or stored in cloud storage and may include data, including DNA/RNA/protein sequences and related data, from a large number of different labs, customers, locations, or the like. The stored data may be accessible to a classification system that includes a classification model, neural network, or other machine learning algorithm. The classification system may classify the data (or sample associated with the data) as including a particular type of tumor molecular abnormality or genetic variant. For example, the classification system may analyze each a DNA/RNA/protein sequence to classify or detect a particular type of tumor molecular abnormality or genetic variant. A DNA/RNA/protein sequence may be classified as a particular type of tumor molecular abnormality or genetic variant.

Based on classification of the type of tumor molecular abnormality or genetic variant within a sample or specimen, one or more clinical recommendations 414 may be generated providing recommendations, interpretations and options for the particular type of tumor molecular abnormality or genetic mutation discovered. Embodiments of clinical recommendation 414 are illustrated in FIGS. 7A and 7B. The clinical recommendation 414 may be generated based on the classification of DNA/RNA/protein sequences found in specimens and a specific treatment option, including needed drugs to treat the health condition. The clinical recommendation 414 may be automatically generated specific to the specimen information, patient information, physician information and/or the corresponding specimen information and interpretation. Examples of specimen information may include a surgical procedure date, a source of the specimen, a primary tumor site, a date the specimen was received, a specimen identification number or serial number, and/or a clinical diagnosis. Examples of patient information may include a patient's name, a patient's identification number, and/or a patient's date of birth. Examples of physician information may include an ordering physician, and/or a pathologist. Examples of specimen information and interpretation may include recommendations based on the genomic profile of a patient's tumor, therapeutic interventions or options, rank order associated with the best therapeutic intervention or option. In an embodiment, the information and interpretation of the specimen may be provided by the molecular tumor board. In an embodiment, the information and interpretation of the specimen may be provided by the classification system 104. In an embodiment, the information and interpretation of the specimen may be provided by a combination of the molecular tumor board and the classification system 404.

In one embodiment, a clinical recommendation 414 may include the alteration detected or otherwise determined, the therapy to treat the alteration, and the rank order. The clinical recommendation may be provided as a general report for a specific specimen or may be general to the specific alteration.

Embodiments disclosed herein may provide significant utility and benefits. At least some embodiments disclosed herein enable the full classification of DNA/RNA/protein sequences and alterations. Generally, treating physicians/oncologists may not have the requisite experience or background to identify and determine the best course of treatment or options for treatment based on a specific alteration. The disclosure provides such treating physicians/oncologists with access to a molecular tumor board and machine learning classification system that can result in a clinical recommendation that may provide options and interpretations, including suggesting whether additional tests are needed, and/or providing effective treatment options based on the data and interpretations. Additionally, it can sometimes take a large amount of time to perform an analysis and classification for individual treating physicians/oncologists. This time can be saved by using machine learning algorithms and/or deep neural networks for automated computer or machine learning classification. Accuracy may be increased because a greater portion of the DNA/RNA/protein sequence is actually analyzed and because embodiments of machine learning algorithms or models may provide greater classification accuracy for a tumor or DNA/RNA/protein sequence and even for a larger number of different DNA/RNA/protein sequences. Furthermore, oncologists or others may order tests and receive clinical recommendations and thereby obtain input from experts in classification, and/or expert machine learning classification.

Embodiments disclosed herein further allow for the long-term storage and use of specimen information relating to a tumor or DNA/RNA/protein sequence stored in a central location. Machine learning algorithms may be refined based on the large corpus of data and thus improved particle identification algorithms and machine learning results may be obtained.

In embodiments where the classification system 404 is accessible from a remote location, such as via the Internet, significantly improved machine learning and classification may be possible. For example, in machine learning applications the cost of obtaining data and obtaining annotations of the data (e.g., an indication of a classification) can be extremely time consuming and/or difficult to obtain. The remotely accessible classification system 404, and the molecular tumor board 416, may train algorithms based on all data of the same type and thus those accessing the classification system 404 may obtain the benefits of large datasets and the expertise of the tumor board that a party may not otherwise be able to obtain. For example, some types of examinations may not occur frequently enough within a given organization to obtain enough data to train a machine learning model or neural network. By sharing data among different locations and even organizations, even examinations that occur infrequently for each organization may occur frequently enough in combination to adequately train machine learning models or networks.

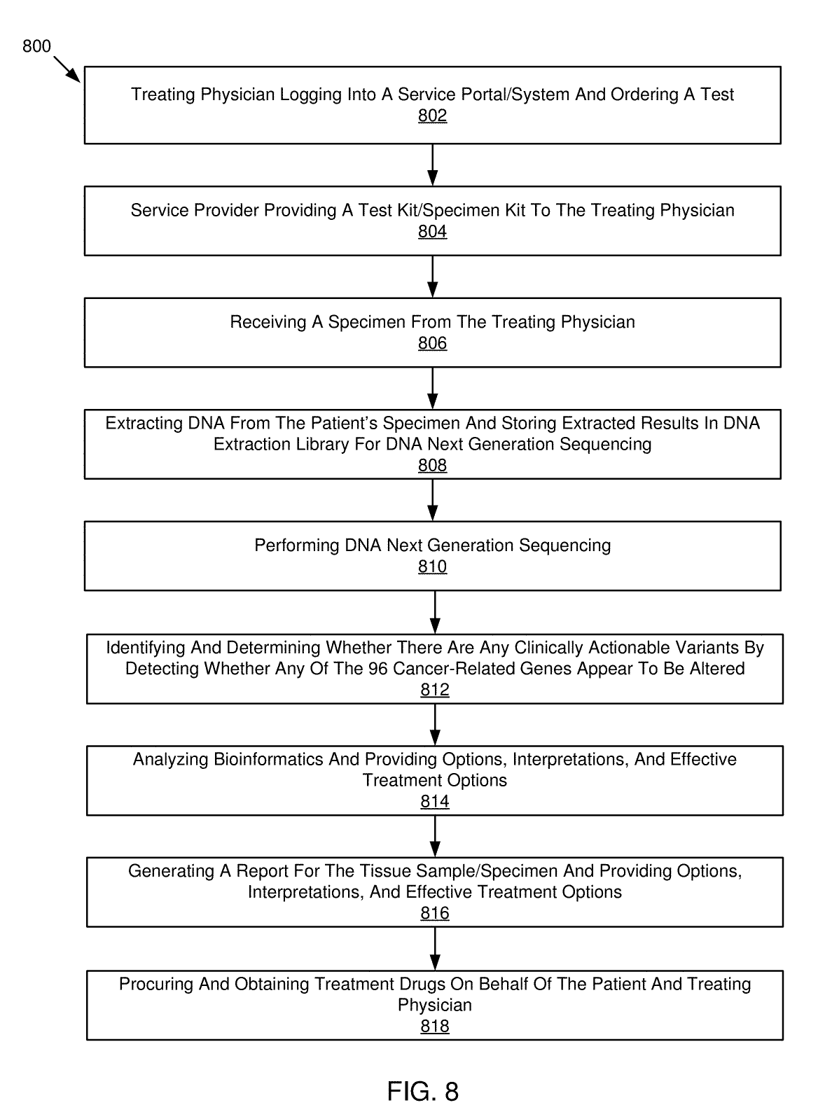

Referring now to FIG. 8, a schematic flow chart diagram illustrating a method 800 for classifying or interpreting genomic results in a tissue sample or specimen is illustrated. The method 800 may be performed by a classification system, such as the classification system 404 of FIG. 4.

The method 800 may begin when a treating physician 402, for example, an oncologist, or other health care provider logs into a service portal/system at 802 over a computer network 410 or otherwise and orders a test 401 from a service provider 403 for a targeted cancer panel that detects 96 genomic alterations. The service provider 403 may send or otherwise provide at 804 a specimen or sample kit (test kit) to the treating physician/oncologist 402 to obtain a biopsy or tumor sample 405 from a patient 403. The sample 405 is sent from the treating oncologist 402 and received by the service provider 403 and/or a pathology laboratory 408. The pathology laboratory 408 extracts DNA from the patient's tumor specimen or sample and stores the extracted results in a DNA extraction library 412 for DNA next generation sequencing at 808. DNA next generation sequencing may be performed at 8. The service provider may then identify whether there are any clinically actionable variants by detecting whether any of the cancer-related genes appear altered in the gene sequence at 812. The service provider 403 may also analyze the gene sequence to determine what, if any, genetic variants exist. A molecular tumor board 416 may comprise cancer and genomic experts, scientists, and physicians. The molecular tumor board 416 and/or classification system 404 may analyze at 814 the bioinformatics, and provide options and interpretations, including suggesting whether additional tests are needed, and/or providing effective treatment options based on the data and interpretations. The classification system 404 may process the DNA sequences using a machine learning prediction model to classify or detect one or more genetic variants or alterations in the specimen. The classification system 404 may store the information in a library. A clinical recommendation 414 may be generated at 816 that provides the options, interpretations and effective treatment options obtained from the molecular tumor board 416 and/or the classification system 404. The information and recommendations that are compiled into a clinical recommendation 414 that the physician/oncologist 402 can easily access over a computer network 410, including over the internet. In an embodiment of the method 800, the method may further include at 818 procuring and obtaining treatment drugs on behalf of the patient and treating physician/oncologist. The service provider may work directly with the U.S. Food and Drug Administration, or other body of a government, as well as working directly with insurance companies on behalf of the treating physician and patient to provide the required treating drugs, thereby removing the time and expense of ordering and procuring the treating drugs from the treating physician/oncologist.

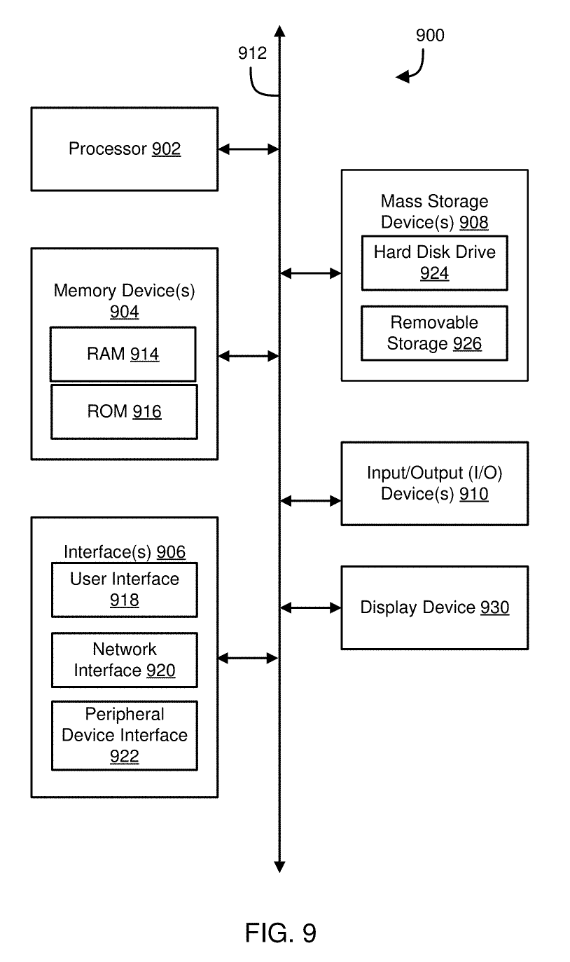

Referring now to FIG. 9, a block diagram of an example computing device 900 is illustrated. Computing device 900 may be used to perform various procedures, such as those discussed herein. Computing device 900 can function as a server, a client, or any other computing entity. Computing device 900 can perform various monitoring functions as discussed herein, and can execute one or more application programs, such as the application programs described herein. Computing device 900 can be any of a wide variety of computing devices, such as a desktop computer, a notebook computer, a server computer, a handheld computer, tablet computer and the like.

Computing device 900 includes one or more processor(s) 902, one or more memory device(s) 904, one or more interface(s) 906, one or more mass storage device(s) 908, one or more Input/Output (I/O) device(s) 910, and a display device 930 all of which are coupled to a bus 912. Processor(s) 902 include one or more processors or controllers that execute instructions stored in memory device(s) 904 and/or mass storage device(s) 908. Processor(s) 902 may also include various types of computer-readable media, such as cache memory.

Memory device(s) 904 include various computer-readable media, for example, volatile memory (e.g., random access memory (RAM) 914) and/or nonvolatile memory (e.g., read-only memory (ROM) 916). Memory device(s) 904 may also include rewritable ROM, such as Flash memory.

Mass storage device(s) 908 include various computer readable media, such as magnetic tapes, magnetic disks, optical disks, solid-state memory (e.g., Flash memory), and so forth. As shown in FIG. 9, a particular mass storage device is a hard disk drive 924. Various drives may also be included in mass storage device(s) 908 to enable reading from and/or writing to the various computer readable media. Mass storage device(s) 908 include removable media 926 and/or non-removable media.

I/O device(s) 910 include various devices that allow data and/or other information to be input to or retrieved from computing device 900. Example I/O device(s) 910 include cursor control devices, keyboards, keypads, microphones, monitors or other display devices, speakers, printers, network interface cards, modems, and the like.

Display device 930 includes any type of device capable of displaying information to one or more users of computing device 900. Examples of display device 930 include a monitor, display terminal, video projection device, and the like.

Interface(s) 906 include various interfaces that allow computing device 900 to interact with other systems, devices, or computing environments. Example interface(s) 906 may include any number of different network interfaces 920, such as interfaces to local area networks (LANs), wide area networks (WANs), wireless networks, and the Internet. Other interface(s) include user interface 918 and peripheral device interface 922. The interface(s) 906 may also include one or more user interface elements 918. The interface(s) 906 may also include one or more peripheral interfaces such as interfaces for printers, pointing devices (mice, track pad, or any suitable user interface now known to those of ordinary skill in the field, or later discovered), keyboards, and the like.

Bus 912 allows processor(s) 902, memory device(s) 904, interface(s) 906, mass storage device(s) 908, and IO device(s) 910 to communicate with one another, as well as other devices or components coupled to bus 912. Bus 912 represents one or more of several types of bus structures, such as a system bus, PCI bus, IEEE bus, USB bus, and so forth.

For purposes of illustration, programs and other executable program components are shown herein as discrete blocks, although it is understood that such programs and components may reside at various times in different storage components of computing device 900, and are executed by processor(s) 902. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

Various techniques, or certain aspects or portions thereof, may take the form of program code (i.e., instructions) embodied in tangible media, such as floppy diskettes, CD-ROMs, hard drives, a non-transitory computer readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, an EPROM, a flash drive, an optical drive, a magnetic hard drive, or another medium for storing electronic data. One or more programs that may implement or utilize the various techniques described herein may use an application programming interface (API), reusable controls, and the like. Such programs may be implemented in a high-level procedural or an object-oriented programming language to communicate with a computer system. However, the program(s) may be implemented in assembly or machine language, if desired. In any case, the language may be a compiled or interpreted language, and combined with hardware implementations.

It should be understood that many of the functional units described in this specification may be implemented as one or more components, which is a term used to more particularly emphasize their implementation independence. For example, a component may be implemented as a hardware circuit comprising custom very large-scale integration (VLSI) circuits or gate arrays, off-the-shelf semiconductors such as logic chips, transistors, or other discrete components. A component may also be implemented in programmable hardware devices such as field programmable gate arrays, programmable array logic, programmable logic devices, or the like.

Components may also be implemented in software for execution by distinct types of processors. An identified component of executable code may, for instance, include one or more physical or logical blocks of computer instructions, which may, for instance, be organized as an object, a procedure, or a function. Nevertheless, the executables of an identified component need not be physically located together, but may include disparate instructions stored in different locations that, when joined logically together, include the component and achieve the stated purpose for the component.

Indeed, a component of executable code may be a single instruction, or many instructions, and may even be distributed over several different code segments, among different programs, and across several memory devices. Similarly, operational data may be identified and illustrated herein within components, and may be embodied in any suitable form and organized within any suitable type of data structure. The operational data may be collected as a single data set, or may be distributed over different locations including over different storage devices, and may exist, at least partially, merely as electronic signals on a system or network. The components may be passive or active, including agents operable to perform desired functions.

Implementations of the disclosure can also be used in cloud computing environments. In this application, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, or any suitable characteristic now known to those of ordinary skill in the field, or later discovered), service models (e.g., Software as a Service (SaaS), Platform as a Service (PaaS), Infrastructure as a Service (IaaS)), and deployment models (e.g., private cloud, community cloud, public cloud, hybrid cloud, or any suitable service type model now known to those of ordinary skill in the field, or later discovered). Databases and servers described with respect to the disclosure can be included in a cloud model.

### EXAMPLES

The following examples pertain to further embodiments.

Example 1 is a method that includes selecting a treatment for a cancer patient. The method includes evaluating a genetic report, the genetic report comprising: molecular data, wherein the molecular data is derived from a sample obtained directly from a cancer patient; and an identification of one or more observed genetic variants within one or more of a DNA sequence, an RNA sequence, and a protein sequence. The method includes identifying members of a list of drug-variant matches, wherein each member of the list of drug-variant matches comprises a drug therapy for a cancer disease, wherein the cancer disease comprises cells that comprise one or more observed genetic variants; and creating a clinical interpretation and recommendation for treatment of the cancer patient.

In Example 2, the genetic report in Example 1 further comprises a categorization of the one or more observed genetic variants into one of a first variant category or a second variant category, the first variant category comprising clinically actionable genetic variants, and the second variant category comprising genetic variants of unknown clinical significance.

In Example 3, the method of any of Examples 1-2 includes identifying members of the list of drug-variant matches further comprises categorizing cells that comprise an observed genetic variant in the first variant category.

In Example 4, the method of any of Examples 1-3 include separating the drug therapies in the members of the list of drug-variant matches into either a first drug therapy category or a second drug therapy category.

In Example 5, the method of any of Examples 1-4 includes the first drug therapy category that comprises drug therapies that are approved by a relevant governing body to treat a cancer disease of a type identified in the cancer patient, and the second drug therapy category comprises drug therapies that are approved by the relevant governing body to treat a cancer disease of a type that is absent from the cancer patient.

In Example 6, the method of any of Examples 1-5 includes assigning higher priority to the first drug therapy category relative to the second drug therapy category.

In Example 7, the method of any of Examples 1-6 includes sub-prioritizing the first drug therapy category and the second drug therapy category to create a sub-prioritized first drug therapy category and a sub-prioritized second drug therapy category based on one or more of the following: clinical data, pre-clinical data, animal study data, and in vitro study data.

In Example 8, the method of any of Examples 1-7 includes the clinical interpretation and recommendation that comprises members of the sub-prioritized first drug therapy category, the sub-prioritized second drug therapy category, or both the sub-prioritized first drug therapy category and the sub-prioritized drug second therapy category.

In Example 9, the method of any of Examples 1-8 includes a third drug therapy category where drugs in clinical development or trials are considered as treatment options for the patient.

In Example 10, the method of any of Examples 1-9 includes assembling a board of experts in the field of oncology.

In Example 11, the method of any of Examples 1-10 includes further-prioritizing the sub-prioritized first drug therapy category based on experiences and expertise of the board to create a prioritized first drug therapy category, and further-prioritizing the sub-prioritized second drug therapy category based on experiences and expertise of the board to create a prioritized second drug therapy category.

In Example 12, the method of any of Examples 1-11 includes members of the first drug therapy category that are associated with clinical data are sub-prioritized higher than members of the first drug therapy category that are exclusively associated with animal study data or in vitro study data, and wherein and the members of the second drug therapy category that are associated with clinical data are sub-prioritized higher than the members of the second therapy category that are exclusively associated with animal study data or in vitro study data.

In Example 13, the method of any of Examples 1-12 includes receiving a DNA, RNA, or protein sample.

In Example 14, the method of any of Examples 1-13 includes generating one or more of the DNA sequence of the DNA sample, the RNA sequence of the RNA sample, and the protein sequence of the protein sample.

In Example 15, the method of any of Examples 1-14 includes identifying the one or more observed genetic variants within the one or more of the DNA sequence, the RNA sequence, and the protein sequence.

In Example 16, the method of any of Examples 1-15 includes categorizing the observed genetic variants into one of the first variant category or the second variant category.

In Example 17, the method of any of Examples 1-16 includes receiving a cancer cell or tumor biopsy.

In Example 18, the method of any of Examples 1-17 includes isolating the DNA, RNA, or protein sample; and generating the sequence of the DNA, RNA, or protein sample.

In Example 19, the method of any of Examples 1-18 includes identifying the one or more observed genetic variants.

In Example 20, the method of any of Examples 1-19 includes classifying the observed genetic variants into one of the first variant category or the second variant category.

In Example 21, the method of any of Examples 1-20 includes identifying a relevant genetic test for the cancer patient.

In Example 22, the method of any of Examples 1-21 includes recommending the relevant genetic test in the clinical recommendation.

In Example 23, the method of any of Examples 1-22 includes providing the clinical interpretation and recommendation to a treating healthcare provider.

In Example 24, the method of any of Examples 1-23 wherein the sample comprises either a solid tumor or a hematological cancer cell.

In Example 25, the method of any of Examples 1-24 includes assisting a treating healthcare provider in the procurement of one or more pharmaceutical compounds, wherein the one or more pharmaceutical compounds are members of the prioritized first drug therapy category, the prioritized second drug therapy category, or both the prioritized first drug therapy category and the prioritized drug second therapy category.

In Example 26, the method of any of Examples 1-25 wherein the one or more pharmaceutical compounds comprises a small molecule.

In Example 27, the method of any of Examples 1-26 wherein the one or more pharmaceutical compounds comprises a biologic.

In Example 28, the method of any of Examples 1-27 wherein the clinical interpretation and recommendation further comprises a recommendation for a surgical procedure.

In Example 29, the method of any of Examples 1-28 wherein the clinical interpretation and recommendation further comprises a recommendation for a radiation therapy.

In Example 30, the method of any of Examples 1-29 wherein the clinical interpretation and recommendation further comprises a recommendation for a surgical procedure.

In Example 31, the method of any of Examples 1-30 wherein the clinical interpretation and recommendation further comprises one or more items from the following list: a list of the clinically actionable variants, a list of the variants of unknown clinical significance, a list of recommended genetic tests, and a list of clinical studies that test the recommended treatment.

Example 32 is a method that includes selecting a treatment for a cancer patient. The method includes generating a sequence of a DNA sample, wherein the DNA sample was isolated from a cancer cell or tissue collected from a cancer patient. The method includes identifying genetic variants within the sequence and comparing the genetic variants to known clinically actionable genetic variants. The method includes classifying the genetic variants into at least one of a first category and a second category, wherein the first category comprises clinically actionable genetic variants; and wherein the second category comprises genetic variants of unknown clinical significance. The method includes identifying members of a first list of therapies for treating a patient diagnosed with a matching cancer disease, wherein the matching cancer disease comprises disease cells comprising at least one genetic variant classified in the first category, and identifying members of a second list of therapies for treating a patient harboring a nonmatching cancer disease, wherein the nonmatching cancer disease consists of cells in which all genetic variants classified in the first category are absent. The method includes prioritizing the members of the first and second lists of therapies according to results of studies that researched the members of the first and second lists of therapies. The method includes sub-prioritizing the members of the first and second lists of therapies based on scientific research and clinical outcomes. The method includes creating a clinical recommendation comprising at least one recommendation for treatment of the patient.

In Example 33, the method of Example 32 wherein the clinical recommendation further comprises one or more items from the following list: a list of the clinically actionable variants, a list of the variants of unknown clinical significance, a list of recommended genetic tests, and a list of clinical studies that test the at least one recommended treatment.

While specific embodiments have been described above, it is to be understood that the disclosure provided is not limited to the precise configuration, steps, and components disclosed. Various modifications, changes, and variations apparent to those of skill in the art may be made in the arrangement, operation, and details of the methods and systems disclosed, with the aid of the present disclosure.

Without further elaboration, it is believed that one skilled in the art can use the preceding description to utilize the present disclosure to its fullest extent. The examples and embodiments disclosed herein are to be construed as merely illustrative and exemplary and not a limitation of the scope of the present disclosure in any way. It will be apparent to those having skill in the art that many changes may be made to the details of the above-described embodiments without departing from the underlying principles of the disclosure. The scope of the present disclosure should, therefore. be determined only by the following claims.

What is claimed is:

1. A method for selecting a treatment for a cancer patient comprising:
evaluating a genetic report, the genetic report comprising:
molecular data, wherein the molecular data is derived from a sample obtained directly from a cancer patient; and
an identification of one or more observed genetic variants within one or more of a DNA sequence, an RNA sequence, and a protein sequence;
identifying members of a list of drug-variant matches, wherein each member of the list of drug-variant matches comprises a drug therapy for a cancer disease, wherein the cancer disease comprises cells that comprise one or more observed genetic variants; and
creating a clinical interpretation and recommendation for treatment of the cancer patient.

2. The method of claim 1, wherein the genetic report further comprises a categorization of the one or more observed genetic variants into one of a first variant category or a second variant category, the first variant category comprising clinically actionable genetic variants, and the second variant category comprising genetic variants of unknown clinical significance;
wherein identifying members of the list of drug-variant matches further comprises categorizing cells that comprise an observed genetic variant in the first variant category;
separating the drug therapies in the members of the list of drug-variant matches into either a first drug therapy category or a second drug therapy category;
wherein the first drug therapy category comprises drug therapies that are approved by a relevant governing body to treat a cancer disease of a type identified in the cancer patient, and
wherein the second drug therapy category comprises drug therapies that are approved by the relevant governing body to treat a cancer disease of a type that is absent from the cancer patient;
assigning higher priority to the first drug therapy category relative to the second drug therapy category;
sub-prioritizing the first drug therapy category and the second drug therapy category to create a sub-prioritized first drug therapy category and a sub-prioritized second drug therapy category based on one or more of the following: clinical data, pre-clinical data, animal study data, and in vitro study data; and
wherein the clinical interpretation and recommendation comprises members of the sub-prioritized first drug therapy category, the sub-prioritized second drug therapy category, or both the sub-prioritized first drug therapy category and the sub-prioritized drug second therapy category.

3. The method of claim 2, further comprising a third drug therapy category where drugs in clinical development or trials are considered as treatment options for the patient.

4. The method of claim 2, further comprising assembling a board of experts in the field of oncology.

5. The method of claim 4, further comprising:
further-prioritizing the sub-prioritized first drug therapy category based on experiences and expertise of the board to create a prioritized first drug therapy category; and
further-prioritizing the sub-prioritized second drug therapy category based on experiences and expertise of the board to create a prioritized second drug therapy category.

6. The method of claim 2, wherein members of the first drug therapy category that are associated with clinical data are sub-prioritized higher than members of the first drug therapy category that are exclusively associated with animal study data or in vitro study data, and wherein and the members of the second drug therapy category that are associated with clinical data are sub-prioritized higher than the members of the second therapy category that are exclusively associated with animal study data or in vitro study data.

7. The method of claim 1, further comprising receiving a DNA, RNA, or protein sample.

8. The method of claim 7, further comprising generating one or more of the DNA sequence of the DNA sample, the RNA sequence of the RNA sample, and the protein sequence of the protein sample.

9. The method of claim 8, further comprising identifying the one or more observed genetic variants within the one or more of the DNA sequence, the RNA sequence, and the protein sequence.

10. The method of claim 9, further comprising categorizing the observed genetic variants into one of the first variant category or the second variant category.

11. The method of claim 1, further comprising receiving a cancer cell or tumor biopsy.

12. The method of claim 11, further comprising:
isolating the DNA, RNA, or protein sample; and
generating the sequence of the DNA, RNA, or protein sample.

13. The method of claim 12, further comprising identifying the one or more observed genetic variants.

14. The method of claim 12, further comprising classifying the observed genetic variants into one of the first variant category or the second variant category.

15. The method of claim 1, further comprising identifying a relevant genetic test for the cancer patient.

16. The method of claim 15, further comprising recommending the relevant genetic test in the clinical recommendation.

17. The method of claim 1, further comprising providing the clinical interpretation and recommendation to a treating healthcare provider.

18. The method of claim 1, wherein the sample comprises either a solid tumor or a hematological cancer cell.

19. The method of claim 2, further comprising assisting a treating healthcare provider in the procurement of one or more pharmaceutical compounds, wherein the one or more pharmaceutical compounds are members of the prioritized first drug therapy category, the prioritized second drug therapy category, or both the prioritized first drug therapy category and the prioritized drug second therapy category.

20. The method of claim 19, wherein the one or more pharmaceutical compounds comprises a small molecule.

21. The method of claim 19, wherein the one or more pharmaceutical compounds comprises a biologic.

22. The method of claim 2, wherein the clinical interpretation and recommendation further comprises a recommendation for a surgical procedure.

23. The method of claim 2, wherein the clinical interpretation and recommendation further comprises a recommendation for a radiation therapy.

24. The method of claim 23, wherein the clinical interpretation and recommendation further comprises a recommendation for a surgical procedure.

25. The method of claim 2, wherein the clinical interpretation and recommendation further comprises one or more items from the following list: a list of the clinically actionable variants, a list of the variants of unknown clinical significance, a list of recommended genetic tests, and a list of clinical studies that test the recommended treatment.

26. A method for selecting a treatment for a cancer patient comprising:
generating a sequence of a DNA sample, wherein the DNA sample was isolated from a cancer cell or tissue collected from a cancer patient;
identifying genetic variants within the sequence;
comparing the genetic variants to known clinically actionable genetic variants;
classifying the genetic variants into at least one of a first category and a second category, wherein the first category comprises clinically actionable genetic variants; and wherein the second category comprises genetic variants of unknown clinical significance;
identifying members of a first list of therapies for treating a patient diagnosed with a matching cancer disease, wherein the matching cancer disease comprises disease cells comprising at least one genetic variant classified in the first category;
identifying members of a second list of therapies for treating a patient harboring a nonmatching cancer disease, wherein the nonmatching cancer disease consists of cells in which all genetic variants classified in the first category are absent;
prioritizing the members of the first and second lists of therapies according to results of studies that researched the members of the first and second lists of therapies;
sub-prioritizing the members of the first and second lists of therapies based on scientific research and clinical outcomes; and
creating a clinical recommendation comprising at least one recommendation for treatment of the patient.

27. The method of claim 26, wherein the clinical recommendation further comprises one or more items from the following list: a list of the clinically actionable variants, a list of the variants of unknown clinical significance, a list of recommended genetic tests, and a list of clinical studies that test the at least one recommended treatment.
